(19) United States
(12) Patent Application Publication
(10) Pub. No.: US 2008/0155647 A1
(43) Pub. Date: Jun. 26, 2008

(54) ACCESS CONTROL SYSTEM

(76) Inventors: Toui Miyawaki, Kawasaki (JP); Kiminori Sugauchi, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/945,461

(22) Filed: Nov. 27, 2007

(30) Foreign Application Priority Data
Nov. 28, 2006 (JP) 2006-320817
Oct. 10, 2007 (JP) 2007-263887

(51) Int. Cl. G06F 21/20

(52) U.S. Cl. 726/1

(57) ABSTRACT

A technique which can properly control resources which can be disclosed for an access through a relay apparatus and can improve a security is provided. In a management server, there are executed: a notifying processing module which receives a using request for the resources; a situation information collecting module which, when the using request is received, obtains situation information regarding a case where the resources (server, etc.) are used by a user terminal; a policy collating module which decides the use-permissible resources among the resources on the basis of the situation information; and a filtering control module which controls a filtering by a switch so that an access to the use-permissible resources through a blade PC can be made.

### INCORPORATION BY REFERENCE

The present application claims priority from Japanese application JP2006-320817 filed on Nov. 28, 2006, and JP2007-263887 filed on Oct. 10, 2007, the content of which is hereby incorporated by reference into this application.

### BACKGROUND OF THE INVENTION

### Field of the Invention

The invention relates to an access control technique under an environment for making what is called a remote access in which resources are accessed from a user terminal which is operated by the user through a network and a relay apparatus by using, for example, an Internet Protocol (IP).

Hitherto, as an example of a form for realizing the remote access, there has been known a thin client system constructed in such a manner that a terminal which is directly operated by the user is set to a thin client terminal having only minimum necessary functions for making the remote access and necessary application and data are provided for a server side serving as a remote access destination. Unlike a system in the related art in which application and data have been provided for a terminal of each user, according to such a thin client system, since it is unnecessary for an administrator to manage the application, data, and the like of the terminal of each user and they can be managed in a lump on the server side, there is an advantage of cost reduction.

In recent years, a problem of an information leakage is becoming serious and the thin client system is widely being spread from viewpoints of not only the advantage of cost reduction but also an advantage on security in which there is no need to keep top secret information under the user's hand.

The access to the resources on the network is controlled in order to keep a security in the network. For example, a firewall having a filtering function obtains an IP address of an apparatus which has accessed from an IP address of a transmitting source of a packet and controls a resource disclosure range which can be accessed.

As another technique, a technique in which access control can be made even in an access from a computer to which an IP address is dynamically allocated has been disclosed in JP-A-10-28144 as the Patent document 1.

### SUMMARY OF THE INVENTION

For example, assuming that the control of the resource disclosure range which is made by the transmitting source IP address of the packet is executed under the remote access environment, the packet which is transmitted from a user terminal which is directly operated by the user is guided to a firewall through a relay apparatus, so that the packet in which the IP address of the relay apparatus is the transmitting source is guided to the firewall. That is, in the case of accessing through the same relay apparatus, the IP address of the same relay apparatus always reaches the firewall. Even if the user tried to access the resources by the user terminal from an arbitrary location through the relay apparatus, the same resource is always disclosed.

This means that, for example, even in the case where the user accesses the resources from the inside of a company or even in the case where the user accesses the resources from the outside of the company such as a destination of a business trip or the like, he can access the resources in the same range, a possibility of information leakage rises, and it is undesirable from a viewpoint of the security.

Even in the technique of Patent Document 1, the access control based on user authentication information is made and, in the case of the same user, the disclosure range of the resources is identical, a possibility of information leakage similarly rises, and it is undesirable from a viewpoint of the security.

The invention is made in consideration of the above problems and it is an object of the invention to provide such a technique that a range of resources which can be disclosed can be properly controlled in response to an access through a relay apparatus and a security can be improved.

To accomplish the above object, the invention is made by paying an attention to a point that a range of resources which are necessary for the user or a range of resources which the administrator considers that he may disclose to the user differs depending on situation information regarding a case where the resources are used by a user terminal such as information regarding a position where the user exists, information of a schedule, information regarding an object of accessing the resources.

According to an embodiment of the invention, there is provided an access control system comprising: one or more resources; a relay apparatus which relays accesses to the resources from a user terminal which is operated by a user; and a filtering apparatus which is provided between the resources and the relay apparatus and executes a filtering in the access to the resources from the relay apparatus side, wherein the access control system further has a control server which controls the filtering of the filtering apparatus, and the control server has a receiving unit which receives a using request to the resources by the user terminal, an obtaining unit which obtains situation information regarding a case where the resources are used by the user terminal when the using request is received, a deciding unit which decides the use-permissible resources among the resources on the basis of the situation information, and a control unit which controls the filtering by the filtering apparatus so that the access to the use-permissible resources through the relay apparatus can be made.

According to the invention, to the access through the relay apparatus, the range of the resources which can be disclosed can be properly controlled and the security can be improved.

The other objects and methods of achieving the objects will be readily understood in conjunction with the description of embodiments of the present invention and the drawings.

### BRIEF DESCRIPTION OF THE DRAWINGS

FIG. 1 is a constructional diagram of a network system according to an embodiment of the invention;

FIG. 2 is a sequence diagram showing the operation of the network system according to the first embodiment of the invention;

FIGS. 3A to 3D are diagrams showing data structures of various notifications according to the first embodiment of the invention;

FIG. 4 is a diagram showing a data structure of a filtering policy according to the first embodiment of the invention;

FIG. 5 is a diagram for explaining a construction and the operation of a management server according to the first embodiment of the invention;

FIG. 6 is a diagram for explaining a schematic construction and the operation of a network system according to the second embodiment of the invention;

FIG. 7 is a diagram for explaining a schematic construction and the operation of a network system according to the third embodiment of the invention;

FIG. 8 is a diagram for explaining a schematic construction and the operation of a network system according to the fifth embodiment of the invention;

FIG. 9 is a sequence diagram showing the operation of the network system according to the fifth embodiment of the invention;

FIG. 10 is a diagram for explaining a schematic construction and the operation of a resource disclosure range control agent according to the fifth embodiment of the invention;

FIG. 11 is a sequence diagram showing the operation of the resource disclosure range control agent according to the fifth embodiment of the invention;

FIG. 12 is a diagram for explaining a schematic construction and the operation of a network system according to the sixth embodiment of the invention;

FIG. 13 is a sequence diagram showing the operation of the network system according to the sixth embodiment of the invention;

FIG. 14 is a diagram showing a data structure of a database in an entering/leaving room management server according to the sixth embodiment of the invention;

FIG. 15 is a diagram showing a data structure of a filtering policy according to the sixth embodiment of the invention;

FIG. 16 is a diagram showing another form of the data structure of the database in the entering/leaving room management server according to the sixth embodiment of the invention;

FIG. 17 is a sequence diagram showing the operation of a user access according to the sixth embodiment of the invention;

FIG. 18 is a diagram for explaining a schematic construction and the operation of a network system according to the eighth embodiment of the invention;

FIG. 19 is a diagram for explaining a schematic construction and the operation of a network system according to the tenth embodiment of the invention;

FIGS. 20A and 20B are diagrams showing data structures of a request and a response packet at the time of a multi-access according to the tenth embodiment of the invention;

FIGS. 21A and 21B are diagrams showing data structures of multi-access management files according to the tenth embodiment of the invention;

FIG. 22 is a diagram for explaining a schematic construction and the operation as another form of the network system according to the tenth embodiment of the invention;

FIGS. 23A and 23B are flowcharts showing a deciding procedure of the filtering policy according to the first embodiment of the invention;

FIG. 24 is a diagram for explaining a schematic construction and the operation of a network system according to the fourteenth embodiment of the invention; and

FIG. 25 is a diagram showing a data structure of a using request notification according to the fourteenth embodiment of the invention.

### DETAILED DESCRIPTION OF THE EMBODIMENTS

Embodiments of the invention will now be described with reference to the drawings. The embodiments which will now be described hereinbelow do not limit the invention according to Claims and all of combinations of features described in the embodiments are not always essential to solving means of the invention.

### Embodiment 1

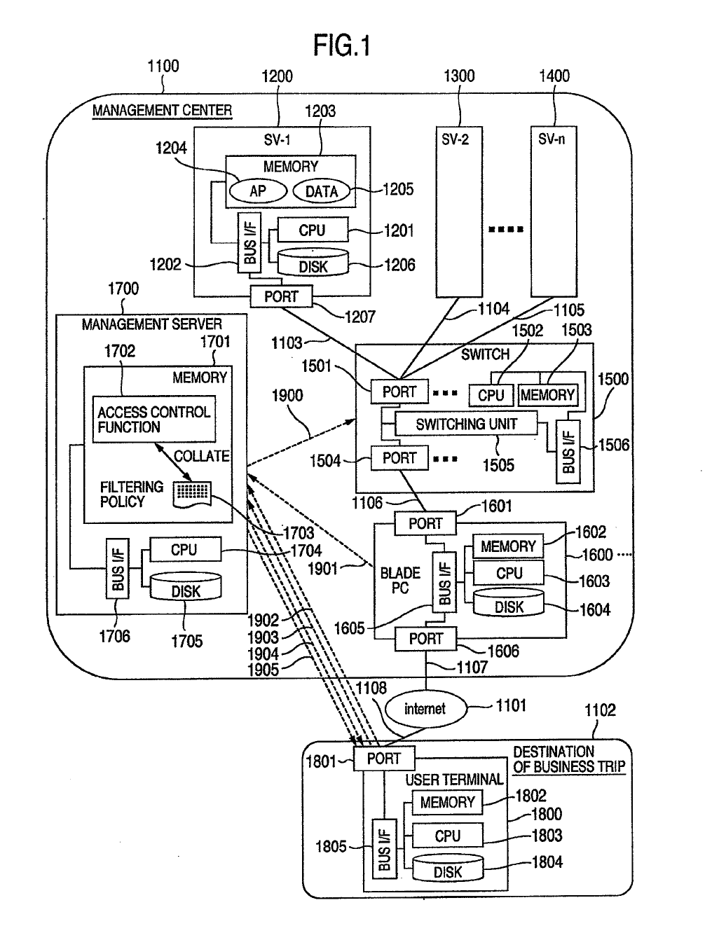

FIG. 1 is a constructional diagram of a thin client system as an example of a network system including an access control system according to the embodiment.

A thin client system 1100 has n servers 1200, 1300, and 1400 as resources. The n servers 1200 and the like are connected to blade PC 1600 (and blade PCs having the same configuration as the PC 1600) as examples of relay terminals through a switch 1500 as an example of a filtering apparatus. The blade PCs 1600 and the like are connected to an Internet 1101 as an example of a network. Although the network is conveniently assumed to be the Internet 1101 in consideration of a connection from a remote place in the embodiment, the network may be, for example, an Intranet, a network in a management center, or another arbitrary network.

The switch 1500 and a plurality of blade PCs 1600, and the like are connected to a management server 1700 as an example of a control server through a network (not shown). The management server 1700 is further connected to the Internet 1101 by the network (not shown). In the embodiment, the servers 1200, 1300, 1400, and the like, the switch 1500, the blade PCs 1600 and the like and the management server 1700 are provided in the management center. A user terminal 1800 existing in, for example, a destination 1102 of a business trip is connected to the Internet 1101. According to such a construction, when the user operates the user terminal 1800, the user terminal 1800 can access the server 1200 or the like through the blade PC 1600 or the like. The user terminal 1800 in the embodiment is constructed by a memory 1802, a CPU 1803, an HDD 1804, and a port 1801 and they are connected by a bus I/F 1805. The port 1801 is connected to the Internet 1101 through an IP network line 1108.

Since the n servers 1200, 1300, . . . , and 1400 have a similar construction, it is now assumed that a construction of the server 1200 will be described here. Data held in hard disk drives (HDDs) and memories of the servers 1200, 1300, . . . , and 1400 may be different or identical. The server 1200 has a memory 1203, a CPU (Central Processing Unit) 1201, and an HDD 1206 which have been connected by a bus interface (bus I/F) 1202. An application 1204 which is used by the user can be activated or held in the memory 1203 and data (user work data) 1205 which is used for work by the user can be also held. The server 1200 has a port 1207 which can be connected to an IP network line. In the embodiment, the port 1207 has been connected to the switch 1500 through an IP network line 1103. In the embodiment, the servers 1300, . . . , and 1400 have also been connected to the switch 1500 through IP network lines 1104 and 1105.

The switch 1500 has a CPU 1502, a memory 1503, a switching unit 1505, and ports 1501 and 1504 which have been connected by a bus I/F 1506, a port for management (not shown) for receiving communication of access control from the management server 1700, and the like. The switching unit 1505 executes a filtering process, mainly by itself, in the communication between the ports 1501 and 1504 in accordance with a filtering request, which will be described hereinafter, from the management server 1700. In the embodiment, the switching unit 1505 is set so that resources cannot be used from all user terminals just after the activation of the switch 1500. That is, all ports on the resource side have been set to the disconnecting state. Such a setting can be set by, for example, the switch 1500 itself or may be set by the management server 1700. The setting port 1504 and the like are connected to the plurality of blade PCs 1600 and the like through an IP network line 1106 and the like.

Since the blade PCs 1600 and the like have a similar construction, the blade PC 1600 will be described here. The blade PC 1600 has a memory 1602, a CPU 1603, an HDD 1604, a port 1601, and a port 1606 which have been connected by a bus I/F 1605. The port 1606 has been connected to the Internet 1101 through an IP network line 1107. The ports 1601 and 1606 can be physically constructed by one apparatus or two apparatuses if the port 1601 can communicate with the switch 1500 or if the port 1606 can communicate with the user terminal 1800.

The memory 1602 or HDD 1604 stores situation information regarding a case where the resources are used. As situation information regarding the case where the resources are used, for example, there are: presence information such as a location such as a destination of a business trip or the like where the user exists; schedule information about the user; an object of using the resources; and the like. The user can set those situation information, for example, by connecting the user terminal 1800 to the blade PC 1600. Therefore, in access control, which will be explained hereinafter, flexible control can be made. The CPU 1603 of the blade PC 1600 executes a predetermined program, thereby executing a process for making a response of the situation information regarding the case using the resources stored in the memory 1602 or HDD 1604 to the management server 1700 in accordance with the request from the management server 1700 (for example, refer to 1901). The CPU 1603 of the blade PC 1600 executes a relaying process for receiving a request from the user terminal 1800 through the port 1606, transmitting to the switch 1500 side through the port 1601, receiving data from the switch 1500 side through the port 1601, and transmitting to the user terminal 1800 through the port 1606. In the embodiment, an IP address of the blade PC 1600 is allocated to a transmitting source IP address in a packet of the data which is relayed by the blade PC 1600.

The management server 1700 has a memory 1701, a CPU 1704, and an HDD 1705 as an example of a filtering policy storing unit which have been connected by a bus I/F 1706. The management server 1700 further has a port for management (not shown) for making communication of the access control to the switch 1500 and is connected to the managing port of the switch 1500, the blade PC 1600, and the like by an IP network line (not shown) to which the managing port is connected. The management server 1700 is directly or indirectly connected to the Internet 1101 and can communicate with the user terminal 1800 through the Internet 1101.

An access control function program 1702 for realizing a function, which will be explained hereinafter, and a filtering policy 1703 have been stored in the HDD 1705. The access control function program 1702 is called from the HDD 1705 into the memory 1701 and executed by the CPU 1704. The filtering policy 1703 is called into the memory 1701 and referred to or edited by the CPU 1704. Programs, which will be shown hereinbelow, are subjected to such a process that they are called from the HDD into the memory and executed by the CPU in a manner similar to the access control function program 1702.

The resources mentioned here denote the user terminal, relay apparatus, management server, and the like. More specifically speaking, the resources include: a client blade as a relay apparatus; a virtual machine in a virtual server environment as a relay apparatus; a desk-top PC as a relay apparatus; a server blade as a relay apparatus; a server which can be indirectly accessed from a user environment of a remote site through the relay apparatus or can be directly accessed from the user environment of the remote site; a storing apparatus such as storage apparatus, tape apparatus, or the like; a working environment in the case where the relay apparatus and the storage apparatus are integratedly seen as a storage centric system; a working environment in the case where the user terminal, intervening network, and relay apparatus are integratedly seen as a network boot system; and the like.

A construction and the operation of the management server 1700 will be described in more detail.

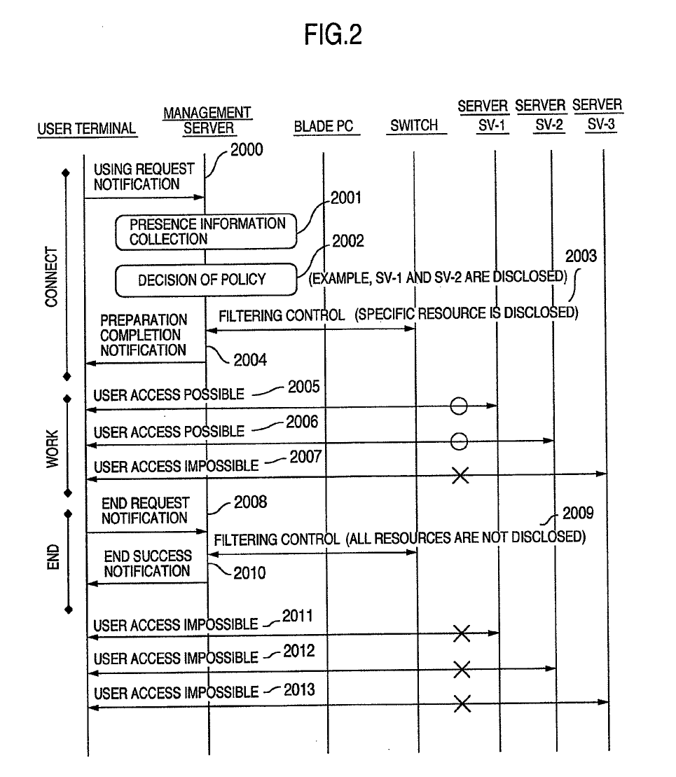

FIG. 2 is a diagram for describing the construction and operation of the management server according to the embodiment.

The access control function program (hereinbelow, access control function PG) 1702 has: a notifying processing module 5000 for constructing a receiving unit; a situation information collecting module 5001 for constructing an obtaining unit; a policy collating module 5002 for constructing a deciding unit; and a filtering control module 5003 for constructing a control unit. The CPU 1704 executes those programs and modules, so that each unit is constructed.

The notifying processing module 5000 is a module for controlling transmission and reception of various notifications to/from the user terminal 1800. As various notifications to/from the user terminal 1800, there are a using request notification 2000, a preparation completion notification 2004, an end request notification 2008, and an end success notification 2010 (refer to 2000 to 2013).

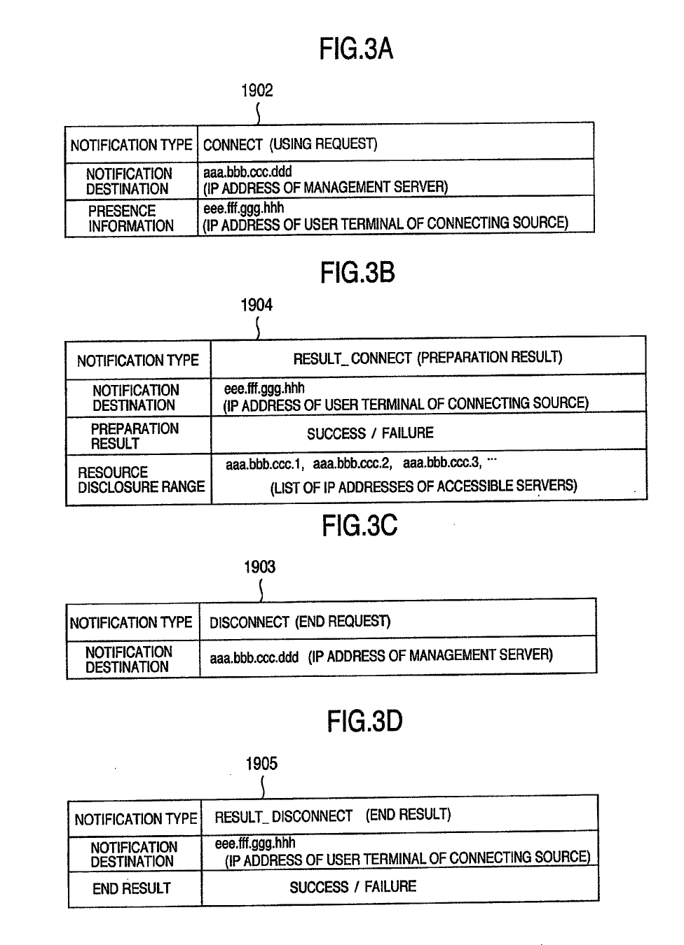

FIGS. 3A to 3D are diagrams showing data structures of the various notifications according to the embodiment.

A using request notification 1902 is a notification which is transmitted when the user requests the start of use of the resources by using the user terminal 1800 and has at least a notification type column, a notification destination column, and a situation information column. An identifier “CONNECT” showing a using request of the resources is set into the notification type column. An IP address of the management server 1700 is set into the notification destination column. An IP address of the user terminal 1800 as a requesting source is set into the situation information column. According to the IP address, there is a case where a specific location where the user terminal 1800 actually exists can be grasped. For example, if the IP address of the user terminal 1800 is an IP address in a certain specific network, a fact that the user terminal has been connected to this network can be grasped. A fact that the user terminal 1800 exists at the location of this network can be grasped.

A preparation result notification 1904 is a notification which is transmitted to the user terminal 1800 by the management server 1700 and has at least a notification type column, a notification destination column, a preparation result column, and a resource disclosure range column. “RESULT_CONNECT” showing a preparation result is set into the notification type column. The IP address of the user terminal 1800 as a requesting source is set into the notification destination column. A result showing whether or not the access control to properly disclose the resources to the user terminal 1800 has been successful is set into the preparation result column. For example, if the preparation has been successful, an identifier “SUCCESS” showing a preparation success is set. If the preparation has failed, an identifier “FAILURE” showing a preparation failure is set. An IP address list of the servers which can be accessed from the user terminal 1800 is set into the resource disclosure range column. The IP address list is set only when the preparation result is “SUCCESS”. When the preparation result is “FAILURE”, nothing is set into the resource disclosure range column.

An end request notification 1903 is a notification which is transmitted when the user finishes the use of the resources using the user terminal 1800 and has at least a notification type column and a notification destination column. “DISCONNECT” showing an end request is set into the notification type column. The IP address of the management server 1700 is set into the notification destination column.

An end result notification 1905 is a notification which is transmitted to the user terminal 1800 by the management server 1700 and has at least a notification type column, a notification destination column, and an end result column. “RESULT_DISCONNECT” showing an end result is set into the notification type column. The IP address of the user terminal 1800 as a requesting source is set into the notification destination column. A result showing whether or not the setting of the accessible resource disclosure range could be initialized is set into the end result column. If the initialization of the resource disclosure range has been successful, the identifier “SUCCESS” showing a success is set in the end result column. If the initialization of the resource disclosure range has failed, an identifier “FAILURE” showing a failure is set in the end result column.

Returning to FIG. 2, when the using request notification 1902 from the user terminal 1800 is received by the notifying processing module 5000 which is executed by the CPU 1704, the CPU 1704 obtains the situation information from the notifying processing module 5000 and the blade PC 1600 by the situation information collecting module 5001.

The situation information which is collected from the notifying processing module 5000 by executing the situation information collecting module 5001 by the CPU 1704 is situation information included in the using request notification 1902 and, specifically, is the IP address of the user terminal 1800 as a requesting source. The situation information which is obtained from the blade PC 1600 by the CPU 1704 through the situation information collecting module 5001 is schedule information of the user, an object of a business trip of the user, a destination of the business trip of the user, an access object of the user, and the like.

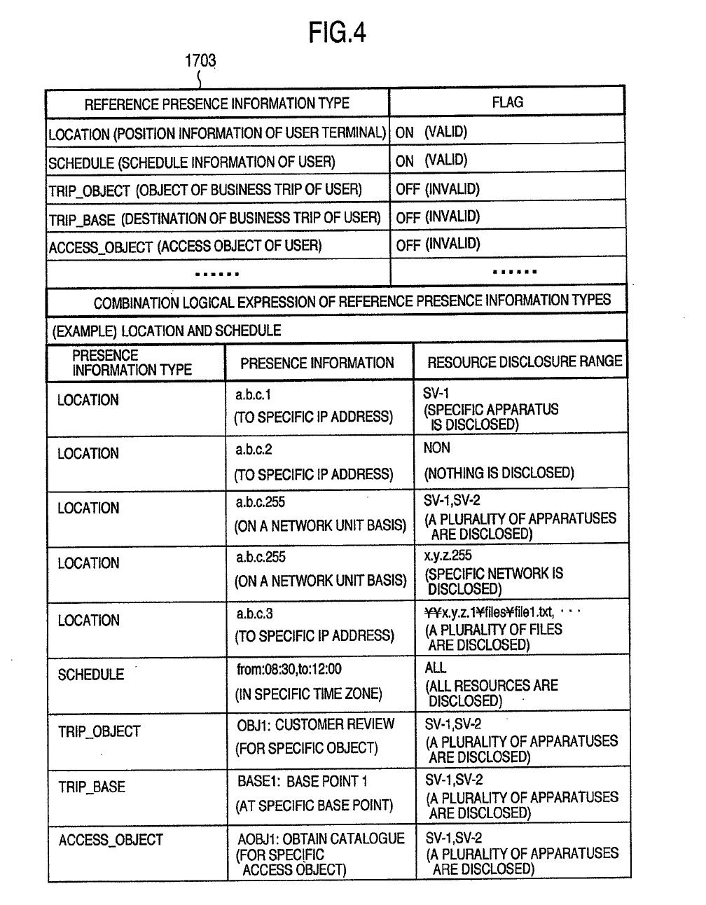

By executing the policy collating module 5002, the CPU 1704 collates the situation information collected by the situation information collecting module 5001 with the filtering policy 1703 (refer to FIG. 4) and decides the policy corresponding to the situation information, that is, the disclosure range of the resources. Further, by executing the filtering control module 5003, the CPU 1704 forms an access control list for the filtering process in accordance with the decided resource disclosure range and transmits a filtering request 1900 including the access control list to the switch 1500, thereby controlling the filtering. For example, information in which the IP address of the blade PC 1600 decided so as to perform the relay of the user terminal 1800 has been made to correspond to the network, a server name, or a file name which can be disclosed to the user terminal 1800 is included in the access control list. As a method of deciding the blade PC for performing the relay of the user terminal 1800, for example, it is sufficient to use a method whereby using situations of a plurality of blade PCs have preliminarily been managed, when the using request notification 1902 is received, the non-used blade PC is detected, and such a blade PC is decided. When the blade PC for performing the relay is decided, the user terminal 1800 is notified of the IP address of the decided blade PC. For example, it is sufficient that such a notification is included in the preparation result notification 1904 which is returned to the user terminal 1800. By this method, the user terminal 1800 can grasp the blade PC of the relevant IP address and access.

FIG. 4 is a diagram showing a data structure of the filtering policy according to the embodiment.

The filtering policy 1703 has a common setting portion 1703a and an individual setting portion 1703b. The common setting portion 1703a has at least a reference situation information type column, a flag column, and a combination logical expression column of the reference situation information types. The individual setting portion 1703b has at least a situation information type column, a situation information column, and a resource disclosure range column.

The filtering policy 1703 is edited and set by the administrator or the user or both of them. It is assumed that the above editing and setting are certainly performed through the access control function PG of the management server 1700. At this time, it is assumed that the access control function PG of the management server 1700 preliminarily has a list of user identifiers owned by the administrator in the management server 1700 and has such a mechanism that if there is an editing/setting request, by discriminating the user identifier, in the case of the user identifier of the administrator, an editing/setting authority to a security policy regarding the accesses of all users is given, and in the case of the user identifier of the general user, only an editing/setting authority to a security policy regarding his own access is given. The access control function PG of the management server 1700 has therein priorities regarding the editing/setting of the user and the administrator. When both of the user and the administrator simultaneously intend to perform the editing/setting of the security policy, which one of the editing work and the setting work is preferentially performed is decided based on the priority and exclusive control is made.

A type of situation information which can be used for the access control is set into the reference situation information type column. As a type of situation information, there are: LOCATION showing a type of position information of the user terminal; SCHEDULE showing a type of schedule information of the user; TRIP_OBJECT showing a type of object of the business trip of the user; TRIP_BASE showing a type of destination of the business trip of the user; ACCESS_OBJECT showing a type of object of the access; and the like.

The corresponding reference situation information type, that is, information of a flag showing whether the reference situation information type of the same line in the diagram is validated or invalidated in the access control is set in the flag column. In the embodiment, in the case of validating the corresponding reference situation information type by the access control, ON is set, and in the case of invalidating the corresponding reference situation information type by the access control, OFF is set. In the embodiment, a plurality of reference situation information types can be simultaneously validated.

A logical expression which specifies a combination of conditions of the reference situation information types validated by the flag is set into the combination logical expression column of the reference situation information types. As a logical expression, an expression using a logical arithmetic operator such as AND (logical product), OR (logical sum), NOT (logical negation), ExOR (exclusive logical sum), or the like regarding a plurality of reference situation information types can be designated. In the diagram, “LOCATION AND SCHEDULE” showing that the access control is made according to a policy which simultaneously satisfies two conditions such as position information of the user terminal and the schedule information of the user is designated. If such a designation has been made, the disclosure range corresponding to the OR of the resource disclosure range in which the situation information type indicates “LOCATION” and the resource disclosure range in which the situation information type indicates “SCHEDULE” becomes the disclosure range which is disclosed on the user terminal 1800 when the situation information in which the situation information type indicates “LOCATION” and the situation information in which the situation information type indicates “SCHEDULE” are satisfied. In the diagram, for example, a policy in which a server resource SV-1 is set to the resource disclosure range and opened for a specific time zone from 08:30 to 12:00 is set for a specific IP address a.b.c.1.

The individual setting portion 1703b has at least a situation information type column, a situation information column, and a resource disclosure range column. A type of situation information which is used as a policy is set into the situation information type column. Predetermined situation information which belongs to the corresponding situation information type is set into the situation information column. As situation information which can be set, for example, an IP address, a network, a time zone, an object of a business trip, a base, an access object, and the like can be set. A range of resources which can be disclosed (resource disclosure range) when the corresponding situation information is satisfied is set into the resource disclosure range column. As a unit of the resource disclosure range, for example, a server unit, a network unit, or a file unit may be used.

For example, in the case where a policy which discloses a specific apparatus (SV-1) is set for the connection from a specific IP address (a.b.c.1), it is sufficient to set “LOCATION” into the situation information type column, set “a.b.c.1” into the situation information column, and set “SV-1” into the resource disclosure range column. In the case where a policy which discloses nothing for the connection from a specific IP address (a.b.c.2), it is sufficient to set “LOCATION” into the situation information type column, set “a.b.c.2” into the situation information column, and set “NON” into the resource disclosure range column. In the case where a policy which discloses a plurality of apparatuses (SV-1, SV-2) is set for the connection from a specific network (a.b.c.255), it is sufficient to set “LOCATION” into the situation information type column, set “a.b.c.255” into the situation information column, and set “SV-1, SV-2” into the resource disclosure range column. “a.b.c.255” denotes a network including IP addresses a.b.c.0 to a.b.c.255. In the case where a policy which discloses a plurality of files (¥¥x.y.z.1¥files¥file.txt, . . . ) is set for the connection from a specific IP address (a.b.c.3), it is sufficient to set “LOCATION” into the situation information type column, set “a.b.c.3” into the situation information column, and set “¥x.y.z.1¥files¥file.txt, . . . ” into the resource disclosure range column.

In the case of setting a policy in which the schedule information of the user is used as a reference, for example, in the case where a policy which discloses all resources is set for the connection in a specific time zone (from 08:30 to 12:00), it is sufficient to set “SCHEDULE” into the situation information type column, set “from: 08:30, to: 12:00” into the situation information column, and set “ALL” into the resource disclosure range column. In the case of setting a policy in which the object of the business trip of the user is used as a reference, for example, in the case where a policy which discloses a plurality of apparatuses (SV-1, SV-2) is set for the connection from the user existing in the destination because of a specific object of the business trip (OBJ1: customer review), it is sufficient to set “TRIP_OBJECT” into the situation information type column, set “OBJ: customer review ” into the situation information column, and set “SV-1, SV-2” into the resource disclosure range column. In the case of setting a policy in which the access object of the user is used as a reference, for example, in the case where a policy which discloses a plurality of apparatuses (SV-1, SV-2) is set for the connection from the user which has made the connection because of a specific access object (AOBJ1: obtainment of a catalogue), it is sufficient to set “ACCESS_OBJECT” into the situation information type column, set “AOBJ: obtainment of a catalogue” into the situation information column, and set “SV-1, SV-2” into the resource disclosure range column.

The operation of a network system according to the first embodiment will now be described.

FIG. 5 is a sequence diagram showing the operation of the network system according to the embodiment. This diagram shows the operation in the case where the user existing in the destination of the business trip uses the resources of the management center.

When the user existing in the destination of the business trip uses the resources of the management center by using the user terminal 1800, if the user instructs the user terminal 1800 to start the use of the resources of the management center by using an input apparatus (not shown) of the user terminal 1800, the user terminal 1800 issues the using request notification 1902 to the management server 1700 (step S1). The management server 1700 which received the using request notification 1902 collects the situation information of the user from the using request notification 1902 and the blade PC 1600 (step S2). Subsequently, the management server 1700 decides the disclosure range of the resources corresponding to the collected situation information with reference to the preset filtering policy 1703 (step S3).

For example, in the case where a policy of “in the case of the connection from the network of a destination A of a business trip, SV-1 and SV-2, that is, the servers 1200 and 1300 are set to the disclosure range” has been set as a filtering policy 1703, if the IP address showing the position of the user terminal and included in the using request notification 1902 is the IP address in the network of the destination A of the business trip, SV-1 and SV-2 are decided as a disclosure range.

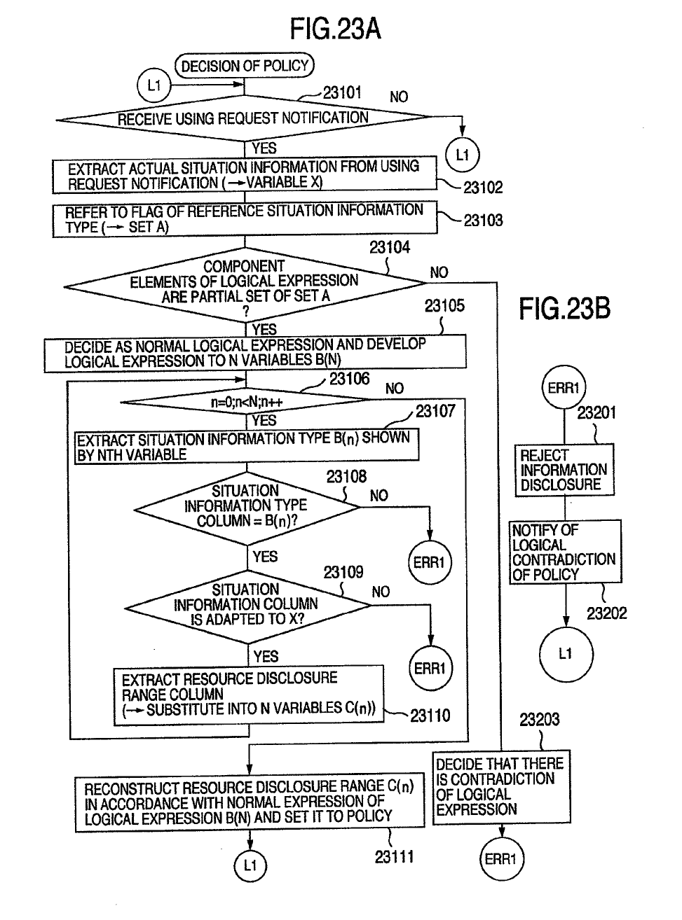

A processing outline has been mentioned in the process S3 in FIG. 5 with respect to the decision of the filtering policy. With respect to a specific deciding procedure of the filtering policy, an example of realizing means will be shown hereinbelow with reference to flowcharts of FIGS. 23A and 23B.

The management server 1700 starts a deciding flow of the filtering policy by using the reception of the using request notification 1902 from the user terminal 1800 as a trigger (23101). A standby state is maintained until the using request notification 1902 is received. It is assumed that at a point of time when the using request notification 1902 is received, the management server 1700 extracts the actual situation information from data included in the packet of the using request notification 1902 and provisionally holds it as a variable X (23102). Subsequently, the filtering policy 1703 is read, a flag of the reference situation information type included in the filtering policy is referred to, and the valid flag is extracted and provisionally held as a set A (23103). Subsequently, whether or not component elements of the combination logical expression of the reference situation information types of the filtering policy 1703 (hereinbelow, simply referred to as a logical expression) are a partial set of the set A is verified (23104). That is, a normality confirmation of the logical expression itself is made. Although it seems that even if the normality confirmation of the logical expression is not made by using such a flag as mentioned above, it is sufficient to make the normality confirmation with respect to the line in which a definition of the information disclosure range of each situation information type has been made, it is wrong. As the number of users increases or an operating policy becomes complicated and advanced, the number of filtering policies increases. However, if the normality confirmation is performed with respect to all definition lines in accordance with such an increase, a processing efficiency deteriorates and, consequently, a quality deterioration for the user is caused. For the administrator, there is such an inconvenience that it is difficult to grasp the situation information types which are valid at present by seeing at a glance or only the situation information types which the administrator wants to validate can be described as a definition. Therefore, the invention intends to enable a using method whereby by managing the filtering policies by using the flag and the logical expression so that the whole of the filtering policies can be managed in a lump, the processing efficiency is improved, a plurality of filtering policies are described and promptly switched according to a situation, or the like. As a result of the above discrimination, if it can be confirmed that the component elements of the logical expression are the partial set of the set A, it is determined that this logical expression is normal, and this logical expression is developed into N variables B(n) (23105). As a result of the above discrimination, if it cannot be confirmed that the component information of the logical expression is the partial set of the set A or if component elements other than the partial set are obviously included, it is determined that this logical expression is contradictory, an error process is executed (23203), and the operating mode is returned to the reception standby mode of the next using request notification (23101). As an error process, the disclosure of the information responsive to the using request notification is refused (23201) and, as a message of a readable format such as pop-up message, E-mail, or the like, the administrator or the user is notified of a fact that the logical contradiction has been found in the filtering policy. Thus, a correction of the filtering policy can be promptly urged (23202). If such an error does not occur, the processing routine advances to a loop process 23106 with conditions. For N elements constructing the logical expression, a variable n starts from an initial value n=0 and the following process is repeated until a condition of n<N is satisfied by adding “1” to n every loop. As a repetitive process, assuming that the situation information type shown by the Nth variable is equal to B(n), first, B(n) is extracted every loop (23107). Subsequently, each definition line of the filtering policy 1703 is searched for and whether or not the situation information type column=B(n), that is, whether or not the it is adapted to the situation information type forming a part of the logical expression is discriminated (23108). If it is not adapted, the disclosure of the information responsive to the using request notification is refused (23201), the error process is executed, and the operating mode is returned to the reception standby mode of the next using request notification (23101). If it is adapted, whether or not a value of the situation information column indicated by the situation information type column is adapted to the value of the actual situation information enclosed in the variable X is discriminated (23109). If it is not adapted, the disclosure of the information responsive to the using request notification is refused (23201), the error process is executed, and the operating mode is returned to the reception standby mode of the next using request notification (23101). If it is adapted, the resource disclosure range column is extracted and is provisionally substituted into N variables C(n) (23110). The loop process as mentioned above is repeated until it is executed to all of the N component elements forming the logical expression. With respect to the values of the variables C(n) thus obtained, a resource disclosure range C(n) is reconstructed in accordance with a combination definition of the resource disclosure ranges shown by a normal expression of the logical expression B(N) and determined as a final filtering policy 1703 responsive to the using request notification 1902 (23111).

Subsequently, the management server 1700 transmits the filtering request 1900 for enabling the user terminal 1800 to access the specific resource showing the decided disclosure range to the switch 1500, thereby executing the filtering control to the switch 1500. On the other hand, the switch 1500 tries to make a setting so that the filtering according to the filtering request can be executed. If the setting is successful, the management server 1700 is notified of the success (step S4). Thus, for example, when communication data in which the blade PC 1600 for performing the relay of the user terminal 1800 at destination A of the business trip is used as a transmitting source is received, if it is communication data to the servers 1200 and 1300 set as a disclosure range, the switch 1500 transmits the communication data to the relevant server. In the case of communication data to other resources, a process for discarding such communication data can be executed.

As a result of the filtering control, if the control is successful, the management server 1700 transmits the preparation result notification 1904 showing the success to the user terminal 1800 (step S5). In the embodiment, a list of servers which can be accessed by the user terminal 1800 and the IP address of the blade PC to be connected are included in the preparation result notification 1904.

In the case where the user terminal 1800 which has received the preparation result notification 1904 accesses the resource such as a server or the like, communication data for accessing such a resource is transmitted to the switch 1500 through the designated blade PC 1600. So long as the access is an access of the user to the servers included in the list of the preparation result notification 1904, since the switch 1500 has been set so as to transmit the communication data for accessing to the resource, the user terminal 1800 can access the resources included in the list. For example, in the case of the access from the destination A of the business trip, SV-1 and SV-2 can be accessed (steps S6 and S7).

In the case of the access to resources which are not included in the list of the preparation result notification 1904, since the switch 1500 has been set so as to discard the communication data for accessing, the user terminal 1800 cannot access the resources which are not included in the list. For example, in the case of the access from the destination A of the business trip, SV-3 cannot be accessed (step S8). Since the range of accessible resources can be controlled in this manner, an unprepared information leakage can be suppressed.

After that, if the user finished the work using the user terminal 1800, the user terminal 1800 transmits the end request notification 1903 to the management server 1700 (step S9). The management server 1700 which has received such a notification transmits a filtering request for setting the resource disclosure range into an initial state, that is, for shutting off the access to the accessible resources to the switch 1500, thereby executing the filtering control to the switch 1500. On the other hand, the switch 1500 tries to make its own setting so that the filtering according to the filtering request can be executed. If the setting is successful, the management server 1700 is notified of the success (step S10). Therefore, for example, if the communication data in which the blade PC 1600 is used as a transmitting source is received, the switch 1500 can execute the process for discarding all communication data. Thus, the information leakage can be suppressed. As a result of the filtering control, if the control is successful, the management server 1700 transmits the end result notification 1905 to the user terminal 1800 (step S1).

For example, when the user terminal 1800 transmits the communication data for accessing the resource to the switch 1500 through the blade PC 1600, the switch 1500 discards all of the communication data for accessing the resource from the blade PC 1600. Therefore, not only SV-3 but also SV-1 and SV-2 which could be accessed during the work cannot be accessed (steps S12, S13, S14). In this manner, the information leakage after completion of the work can be properly suppressed.

As mentioned above, according to the embodiment, the user can access the resources of the proper disclosure range according to the environment of the working location and the situation such as object, time zone, or the like. Even if a login authority to the system was stolen by an illegal user, the information leakage can be minimized.

### Embodiment 2

A network system according to the second embodiment will now be described.

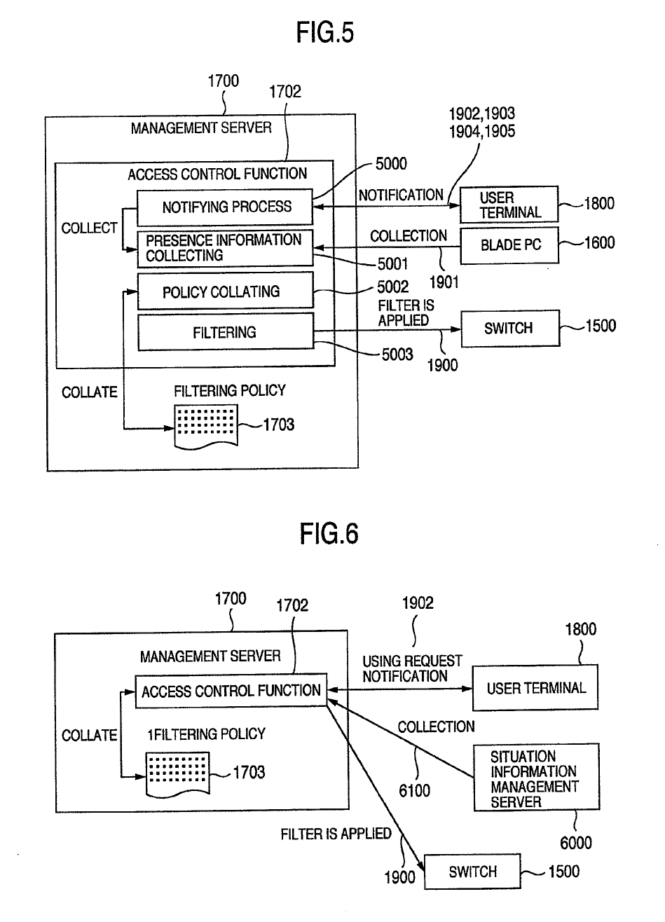

FIG. 6 is a diagram for explaining a schematic construction and the operation of the network system according to the embodiment. In the second embodiment, portions different from those in the first embodiment will be described.

According to the second embodiment, a situation information management server 6000 for managing the situation information of the user in a lump is newly provided in the network system according to the first embodiment, and further, the situation information is collected from the situation information management server 6000 instead of collecting the situation information from each user terminal 1800 and blade PC 1600 (refer to 6100).

The situation information management server 6000 stores and manages the situation information such as schedule information of the user, object of the business trip of the user, destination of the business trip of the user, access object of the user, and the like other than the position information of the user terminal. The access control function PG 1702 of the management server 1700 is a program for executing such processes that when the using request notification 1902 is received from the user terminal 1800, the situation information is collected from the situation information management server 6000, a collation with the filtering policy 1703 is made by using the collected information, and the filtering request 1900 is transmitted to the switch 1500, thereby making the access control. Thus, the CPU 1704 can execute each of the above processes by executing the access control function PG 1702.

As described above, according to the second embodiment, the situation information of the user can be easily and properly managed by the situation information management server.

### Embodiment 3

A network system according to the third embodiment will now be described.

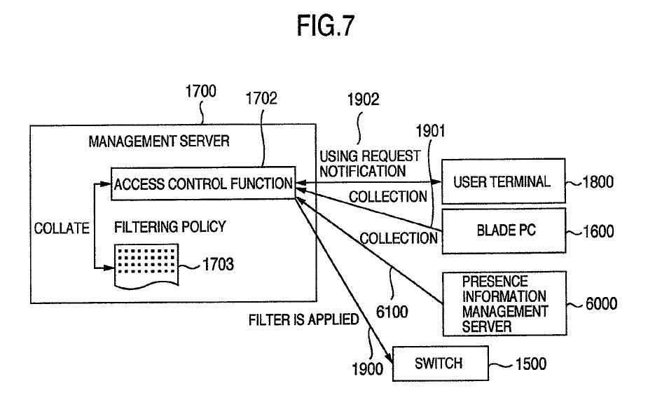

FIG. 7 is a diagram for explaining a schematic construction and the operation of the network system according to the embodiment. In the third embodiment, portions different from those in the first embodiment will be described.

The network system according to the embodiment newly has the situation information management server 6000 in the network system according to the first embodiment. The situation information management server 6000 stores and manages the situation information such as schedule information of the user, object of the business trip of the user, destination of the business trip of the user, access object of the user, and the like other than the position information of the user terminal. The access control function PG 1702 of the management server 1700 according to the third embodiment is a program for executing such processes that when the using request notification 1902 is received from the user terminal 1800, the using request notification 1902 and the situation information from the blade PCs 1600 and the like and from the situation information management server 6000 are collected, a collation with the filtering policy 1703 is made by totally using those situation information, and the filtering request 1900 is transmitted to the switch 1500, thereby making the access control. Thus, the CPU 1704 can execute each of the above processes by executing the access control function PG 1702.

As described above, according to the third embodiment, the situation information can be set at various locations.

### Embodiment 4

A network system according to the fourth embodiment will now be described. This embodiment can be also realized on the basis of any one of the other embodiments.

As for the situation information management server 6000, so long as it can be accessed from apparatuses for executing the access control function PG 1702, a physical layout of such apparatuses is not limited and the number of apparatuses is not limited either. If there are a variety of accessing sources, a possibility that competition (contradiction) of the setting contents occurs rises. As a detection of a problem, since the setting contents themselves have a complicated combination, there is a possibility that a discovery of the competition is delayed. As an influence of the problem, if the discovery of the competition is delayed, there is a possibility that it results in such a critical fault that the user at a remote site perfectly loses business continuity. It is very difficult to previously avoid the contradiction of the policy setting by a visual inspection or the like. Depending on a case where a system scale is enlarged or a setting method, the occurrence of such a situation that a policy of a different resource disclosure range is set for the same situation information and the policy which is logically contradictory is applied to the access control is considered.

Therefore, the access control function PG 1702 according to the embodiment is a program for executing such processes that when collating with the filtering policy 1703 with respect to a plurality of situation information, whether or not there is logical contradiction in the resource disclosure range to be applied is inspected, if there is no logical contradiction, the access control is made by transmitting the filtering request 1900 to the switch 1500, on the other hand, if the logical contradiction exists, the filtering request 1900 to the switch 1500 is not transmitted and the access control is not made.

As for the logical contradiction mentioned here, each of the following cases is called logical contradiction and is set to a detection target: a case where there are non-conformity in the filtering policy and non-conformity between the filtering policy and external information, more specifically speaking, there is competition of a combination of the user identifier, the accessing source IP address, and (the columns are listed) in the filtering policy; a case where there is non-conformity in the outside between resource information (a maximum range which can be provided as resources, performance information, and the like) and an operating state (under operation/not operated/under maintenance/discarded on schedule, and the like) of the actual apparatus or management information showing them and other meta situation information and between information of the resources shown in the policy and states of the actual resources; and a case where there is non-conformity in an action pattern of the user between the policy and the meta situation information.

It is now assumed that the filtering policy 1703 has been stored either in the management server 1700 or in each blade PC 1600 as an example of the relay apparatus. The filtering policy 1703 is a target of the inspection in the embodiment. A storing location of the filtering policy 1703 is preset as an environment variable by an environment setting file or the like stored in the same location as that of the access control function program 1702, so that the management server 1700 recognizes it. This is because the storing location or the number of filtering policies 1703 varies depending on the operating form. In the case of operating in a form in which the filtering policy is interlocked with the management server 1700, the management server 1700 has therein the environment setting file and a description instructing a directory in the management server 1700 as a storing location of the filtering policy 1703 is made in the environment setting file. In the case of a form in which the filtering policy is not interlocked with the management server 1700, that is, in the case of operating by using an agent, each blade PC 1600 as an example of the relay apparatus has therein the environment setting file and a description instructing a directory in its own blade PC 1600 as a storing location of the filtering policy 1703 may be made in the environment setting file or in the case where the filtering policies 1703 of the number as many as a plurality of users are collectively managed by one file on the management server 1700, another server, or the like, a description instructing a directory of such a file may be made.

In the form in which the filtering policy is not interlocked with the management server 1700, that is, in the case of operating by using an agent, an allocation of the blade PC 1600 as an example of the relay apparatus to the user is a fixed allocation. In a form in which the same user always uses the same blade PC 1600, even if the user is not particularly aware of it, no inconvenience occurs. However, in the case of a form in which the blade PC 1600 is dynamically allocated to the user, that is, in the case of a form in which the different users always selectively use one blade PC 1600, if the security policy 1703 has been set on each blade PC 1600, even when the user is switched, since the filtering policy does not trace, even if the same user has been connected under the same conditions, there is a possibility that the different access control is applied. In the case of using such a using method, the filtering policy 1703 is not held on each blade PC 1600 but by setting the filtering policies of the number as many as a plurality of users inside of the management server 1700, another server, or the like, an influence of the dynamic allocation is eliminated or by discriminating the user identifier instead of the IP address of the user terminal 1800 of a connecting source, the access control is made. By such a method, even if a correspondence relation between the user terminal 1800 and the blade PC 1600 changes, it is possible to avoid the improper filtering policy 1703 from being allocated. The access control function PG 1702 is a program for also executing a process for notifying the administrator or the user that the access control has failed by an E-mail, a pop-up message, or the like. Consequently, the CPU 1704 can execute each of the above processes by executing the access control function PG 1702.

With respect to timing when the management server 1700 executes the above inspection, there are the following two patterns in the manual case and the automatic case.

In the case of manually starting the inspection, when the user or the administrator manually starts the inspection by operating the management server 1700 by a dedicated management interface, the inspection is started either at timing when an inspecting request of the user is received from the remote site or at arbitrary timing when the user and the administrator directly issue the inspecting request by using the dedicated management interface which the management server 1700 has.

In the case of automatically starting the inspection, the management server 1700 has therein a timer function, periodically executes the inspection or periodically monitors the presence or absence of updating of a file of the filtering policy 1703, and starts the inspection only when the updating is performed.

The manual inspection and the automatic inspection are independent and it is assumed that the inspecting requests from the user and the administrator are accepted anytime even while the timer for the automatic inspection is operating.

As an action for an inspection result, timing when the action occurs and its contents will be shown below.

If the logical contradiction of the filtering policy 1703 is found in the inspection result at a point of time when the inspection result is obtained irrespective the manual or automatic inspecting method, the management server 1700 instantaneously makes the access control and closes a port of the switch 1500 or a port of a firewall 8300, thereby shutting off the user access. If the logical contradiction of the filtering policy 1703 is not found in the inspection result at a point of time when the inspection result is obtained, the access control associated with the inspection is not made. It is assumed that the access control other than the inspecting process, that is, the access control associated with an ordinary connecting request or end request is applied irrespective of the present process. Thus, a possibility that the access control by the operations of both of the request from the user and the inspection by the administrator competes is considered. However, if the access control competes, it is assumed that maintenance of security performance has preference and the access control process to the inspection result has preference.

The access control process associated with the series of inspection shown above is a procedure which is applied without exception even in the case where the sequence has already progressed to a point where the user can access. If the port of the switch 1500 and the port of the firewall 8300 have already been closed, the closing state is continuously held. If those ports are in the open state, the ports are closed as a rewinding process.

Since the CPU 1704 executes the above processes by executing the access control function PG 1702, a fear of a decrease in security level, a defective operation of the system, or the like that is caused by the filtering policy set by a careless mistake of the user or the administrator can be preliminarily detected and eliminated.

Although the invention has been described above based on a plurality of embodiments, the invention is not limited to the foregoing embodiments but can be applied to other various forms.

For example, although the management server 1700 has been realized by the hardware different from the switch 1500 and the blade PC 1600 in the above embodiments, the invention is not limited to it but can be realized by any hardware so long as it is the hardware such as switch 1500, blade PC 1600, or the like which can communicate with the user terminal 1800.

Although the management server 1700 has dynamically decided the blade PC which relays to the user terminal 1800 and notified the user terminal 1800 of it and the user terminal 1800 has used the notified blade PC in the above embodiments, the invention is not limited to it but it is also possible to use such a construction that, for example, the management server 1700 preliminarily grasps the specific blade PC which is used by the user terminal 1800 and notifies the user terminal 1800 of the specific blade PC. It is also possible to use such a construction that the user terminal 1800 preliminarily grasps the blade PC which is used and uses such a blade PC.

Although the user terminal 1800 has communicated with the management server 1700 without an intervention of the blade PC in the above embodiments, the invention is not limited to it but the user terminal 1800 may communicate with the management server 1700 through the blade PC.

Although the embodiments of the system realized on the assumption that the management server 1700 exists have been described so far, such a requirement that the user wants to assure the similar security performance without the management server can be also presumed in dependence on the customer environment. Therefore, a realizing method of a serverless system will be described in the fifth embodiment.

### Embodiment 5

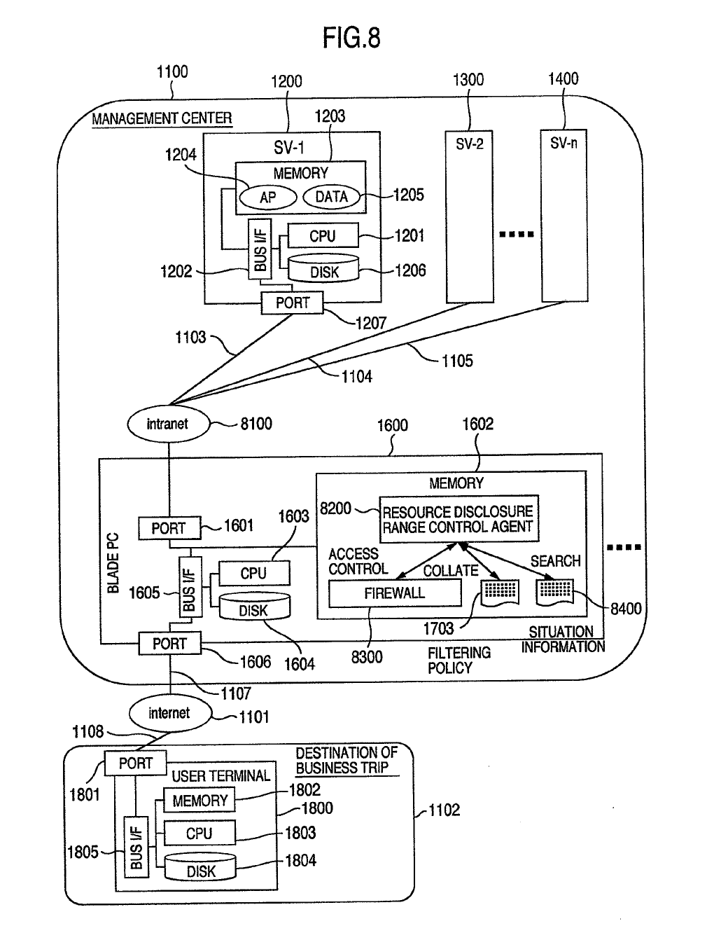

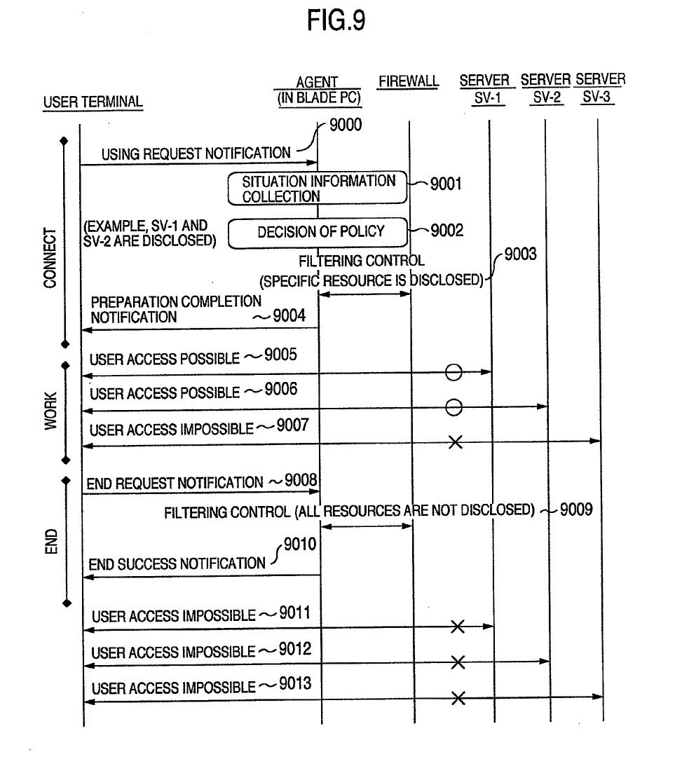

The fifth embodiment will be described hereinbelow by using FIGS. 8 and 9.

FIG. 8 is a diagram for explaining a whole construction of the system according to the embodiment. As compared with FIG. 1, as a physical construction, a construction in which the management server 1700 and the switch 1500 are reduced is used. n servers such as n servers 1200, 1300, 1400, and the like as access destination resources and the blade PC 1600 are directly connected to an Intranet 8100. It is also assumed that a plurality of blade PCs 1600 have been set.

A resource disclosure range control agent 8200 (hereinbelow, agent 8200) has been stored in the hard disk 1604 of the blade PC 1600 and is executed on the memory 1602. The agent 8200 becomes a substitution for the management server 1700 and becomes a main body of the functions such as reading of the filtering policy 1703, reading of situation information 8400, access control, and the like regarding the control of the resource disclosure range.

The number of set blade PCs 1600 is equal to 1 or more and a plurality of blade PCs 1600 may exist. Therefore, a plurality of agents 8200 may also exist in accordance with the number of blade PCs 1600. Also in the case where a plurality of agents 8200 exist, the control of the resource disclosure range is executed independent of the processes of other users in a manner similar to the case of one agent.

In place of the switch 1500, the firewall 8300 which is being executed on the memory 1602 of the blade PC 1600 plays a role of the filtering process. However, an essence of such a requirement that the user wants to reduce the management server is that he wants to reduce the number of apparatuses as management targets as much as possible. Therefore, the switch 1500 which has to be managed by being aware of the correspondence relation between the blade PC 1600 of each user and the port has also been reduced. Therefore, the invention is not limited in particular to the interlocking with the firewall 8300. So long as a function or an apparatus which can be interlocked with the agent 8200, the invention can be realized by the interlocking with the switch 1500 in a manner similar to the first embodiment or the access control may be made by another method.

FIG. 9 is a sequence diagram showing a processing outline in the embodiment.

When connecting to the present system, the user transmits a using request notification 9000 from the user terminal to the agent 8200 on the blade PC 1600. The agent 8200 which has received the using request notification adds the situation information 8400 included in the user request and the situation information 8400 existing on the blade PC 1600 (9001) and decides a policy to control the resource disclosure range (9002). If a discrimination result is correct, the filtering control is made to the firewall and such setting as to permit the user access to the specific resource is made (9003). Subsequently, at the timing when the setting of the filtering has been completed, the agent 8200 transmits a preparation completion notification 9004 to the user terminal 1800, thereby urging the user access. The user terminal 1800 which has received the preparation completion notification tries to access the access destination resource as a target. However, resources other than the access destination resource to which the access has previously been permitted by the firewall 8300 cannot be accessed (9005 to 9007). Even in the access from the destination, the proper security level is assured.

At a point of time when the work from the remote site has been finished, the user transmits an end request notification 9008 to the agent 8200. To the firewall 8300, the agent 8200 which has received the end request notification makes such control 9009 as to close the access to the resource which is being accessed at present. Immediately after completion of the control, an end success notification 9010 is transmitted to the user terminal 1800. After that, since the user has formally finished the work, the using request notification is transmitted again to the agent 8200 and all server resources cannot be accessed for a period of time during which the connecting sequence is formally restarted (9011 to 9013).

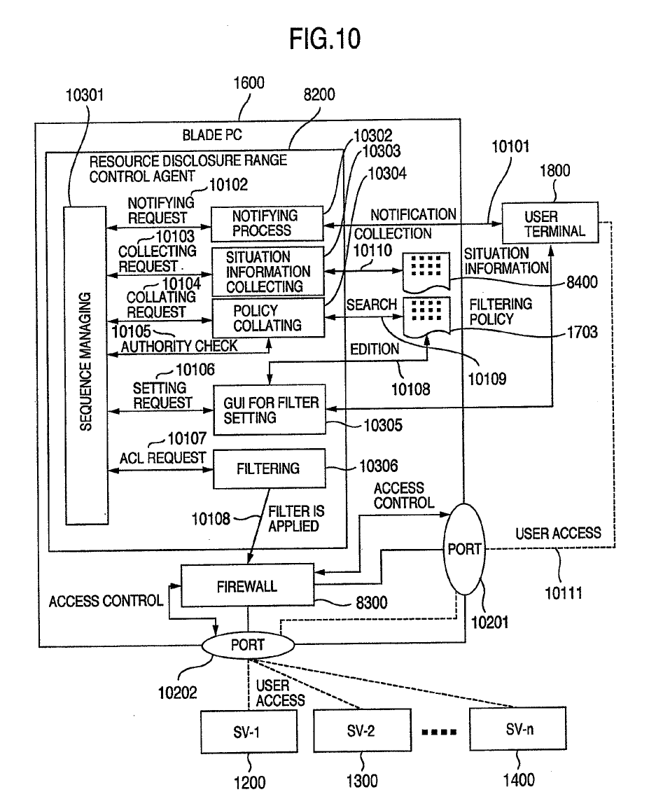

FIG. 10 is a diagram showing a logical internal structure of the blade PC 1600 in the embodiment and is a diagram mainly focused to the resource disclosure agent 8200. The blade PC 1600 has the resource disclosure agent 8200, the firewall 8300, and two ports 10201 and 10202. The user terminal 1800 is connected to the n servers 1200, 1300, and 1400 as access destination resources through the ports 10201 and 10202. The firewall 8300 makes access control of the ports 10201 and 10202. The resource disclosure range control agent 8200 issues an instruction of the access control to the firewall 8300. The resource disclosure range control agent 8200 is constructed by a sequence managing module 10301, a notifying processing module 10302, a situation information collecting module 10303, a policy collating module 10304, a filter setting GUI module 10305, and a filtering module 10306.

The sequence managing module 10301 is a module for integratedly monitoring and controlling the operation of each functional module in the agent 8200.

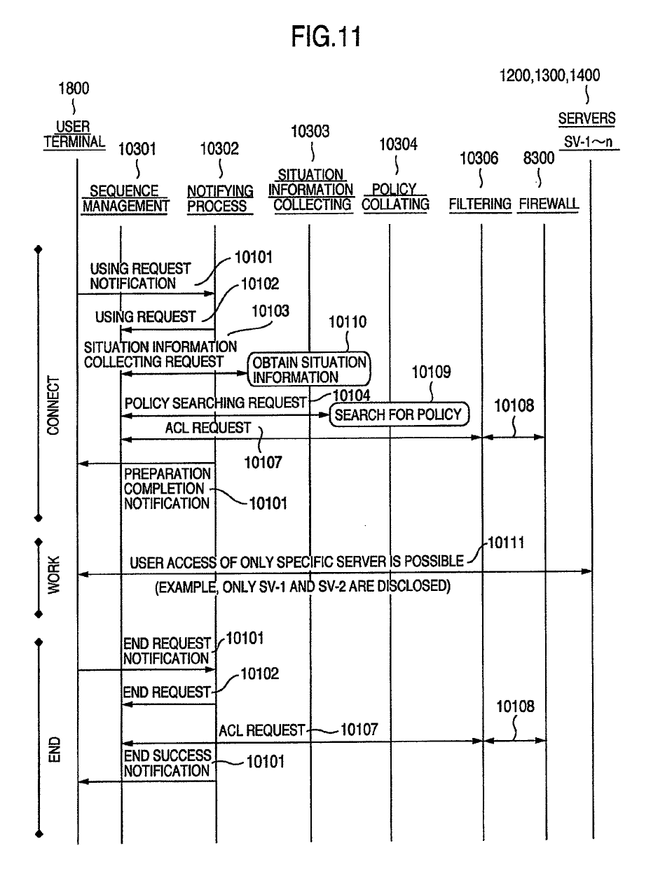

FIG. 11 is a diagram showing the operation of each functional module in FIG. 10.

Upon connection, the user transmits a using request notification 10101 from the user terminal 1800 to the agent 8200. In the agent 8200 which has received the using request notification, it is received by the notifying processing module 10302. In this module, the notification is analyzed and, when it is determined that this notification is a notification showing a use start request from the user, a using request 10102 is issued to the sequence managing module. As for the analysis of the notification, in a manner similar to the first embodiment, by checking a data structure of a notification packet, it is discriminated by examining whether or not such a notification has CONNECT (using request) as a notification type as shown in the using request notification 1902 in FIG. 3A. The sequence managing module 10301 which has received the using request 10102 requests the situation information collecting module 10303 to collect the situation information 8400 serving as a condition of the access control. This module 10303 uses the situation information 8400, as a main data source, included in the using request notification 10101 transmitted from the user terminal 1800, and obtains also the situation information 8400 set in a location where it can be accessed from its own blade (10110) as information in which contents, a schedule, and the like of an application for a business trip have been registered as supplementary situation information of such a data source. And then this module 10303 makes a response of its contents to the sequence managing module 10301 (10103).

Although a case where the supplementary situation information 8400 has been stored on a local disk of its own blade is shown as a simplest example in the embodiment, the invention is not limited to it. So long as the situation information exists in the location where it can be accessed from its own blade, such information can be stored on a specific one of the n servers 1200, 1300, and 1400 as access destination resources or may be stored on another specific blade which has been set for the purpose of storing the supplementary situation information. The location is not particularly limited. Subsequently, the sequence managing module 10301 transmits a searching request of the filtering policy 1703 pivotal for the access control together with the situation information 8400 obtained by a situation information collecting request 10103 (10104). The policy collating module 10304 which has received them searches the inside of the filtering policy 1703 set in the location where it can be accessed from its own blade on the basis of the above situation information 8400 and makes a response of its search result to the sequence managing module 10301 (10104).

Although a case where the filtering policy 1703 has been stored on the local disk of its own blade is shown as a simplest example in the embodiment, the invention is not limited to it. So long as the filtering policy exists in the location where it can be accessed from its own blade, the filtering policy can be stored on a specific one of the n servers 1200, 1300, and 1400 as access destination resources or may be stored on another specific blade which has been set for the purpose of storing the supplementary situation information. The location is not particularly limited. Subsequently, the sequence managing module 10301 transmits an applying request of the filtering process to the filtering module 10306 in accordance with the policy obtained by a policy searching request 10104 (10107). Such a request is made ordinarily by setting/editing a definition file called ACL (Access Control List) although it depends on an installing form of the firewall 8300. The filtering module 10306 makes a filter application by the ACL to the firewall 8300 (10108). The filtering module 10306 receives a result of the filter application as a response from the firewall 8300 and makes a response of it to the sequence managing module 10301 (10107). By using the reception of a success response 10107 of the ACL request as a trigger, the sequence managing module 10301 determines that preparations for the user access have been completed, and transmits a preparation completion notification 10101 to the user terminal 1800. As for a data structure of the notification, the notification is transmitted as a packet having RESULT_CONNECT (preparation result) as a notification type as shown by the preparation completion notification 1904 in FIG. 3B.

By using the reception of the preparation completion notification 10101 by the user terminal 1800 as a trigger, the user terminal 1800 starts the accesses to the n servers 1200, 1300, and 1400 as access destination resources. Since the access limitation by the firewall mentioned above is performed here, the access can be made only in a range adapted to the preset filtering policy 1703 by the present access condition (situation information 8400). Thus, a deterioration of the security which is caused since the information of a necessary amount or more is disclosed although the necessary information is provided in response to an access environment of the destination can be avoided.

Subsequently, after completion of the work from the remote site, the user transmits an end request notification 10101 from the user terminal 1800 to the agent 8200 upon finishing. In the agent 8200 which has received the end request notification, it is received by the notifying processing module 10302. In this module, the notification is analyzed and when it is determined that such a notification is a notification showing an end request from the user, an end request 10102 is issued to the sequence managing module. As for the analysis of the notification, in a manner similar to the first embodiment, by checking a data structure of a notification packet, it is discriminated by examining whether or not such a notification has DISCONNECT (end request) as a notification type as shown in the using request notification 1903 in FIG. 3C. Upon finishing, in a manner similar to the first embodiment, the sequence managing module 10301 transmits such an ACL request 10107 as to disenable the accesses to all of the n servers 1200, 1300, and 1400 to the filtering module 10306 without particularly referring to the filtering policy. The filtering module 10306 which has received the ACL request applies the ACL to the firewall 8300. Since the firewall 8300 makes the access control, all access paths to the user are closed and the security of the system when it is not used is assured (10108). Finally, in response to a closure success of the access paths, the filtering module 10306 transmits it as an end success notification 10101 to the user terminal 1800. As for a data structure of the notification, the notification is transmitted as a packet having RESULT_DISCONNECT (preparation result) as a notification type as shown by the end success notification 1905 in FIG. 3D.

As mentioned above, in the fifth embodiment, by allowing the agent 8200 which operates on each blade PC 1600 to have the function of the management server 1700 for making the control regarding the disclosure range of the resources in the first to fourth embodiments, in the case of a system of a relatively small scale, there is such an effect that even if the management server 1700 is not purposely provided, the operation can be started. Further, there is an effect of suppressing a range of an influence by a fault. Specifically speaking, since the disclosure range of the resources is independently controlled on each blade PC 1600, the fault which occurred in the above control does not appear as an influence on another user as it is but is closed as an influence in each blade PC 1600, that is, of only the relevant user. Only the disclosure range of the resources becomes the control target and the control (change in modification or authority) or the like is not made for the resources themselves. Also in terms of such a point, the system does not have such a construction that an influence is exerted on an accessing state of another user.

### Embodiment 6

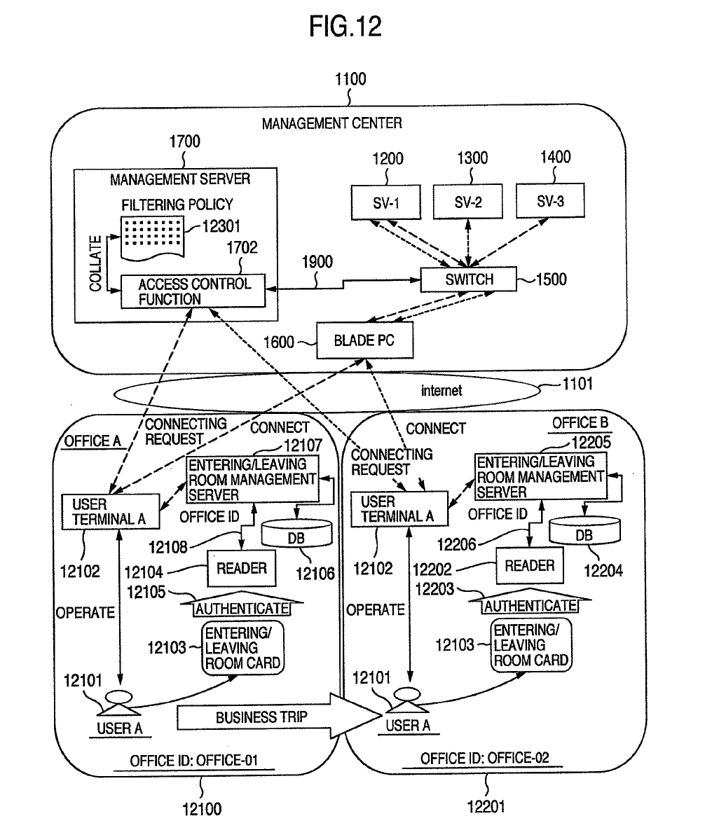

The sixth embodiment will be described hereinbelow with reference to FIGS. 12 to 17.

FIG. 12 is a diagram showing a whole construction of a system in the embodiment. In the embodiment, there is mentioned an embodiment characterized by making a discrimination of situation information based on an identifier for unconditionally identifying an office (hereinbelow, referred to as an office ID) instead of the discrimination of the situation information based on the IP address in the first embodiment. That is, although the discrimination of the situation information and the setting of the filtering policy on a user unit basis are made in the first embodiment, the sixth embodiment relates to an example of the case of making the discrimination of the situation information and the setting of the filtering policy on an office unit basis. In the case of performing such an operation that the security level of each office is identical, such a method is more efficient. Even if attribute information (belonging, office organization, etc.) regarding the user changes, there is no need to change the filtering policy every time, or the like so long as an office where work is executed is identical. Such a method is a function of extending a using width in the actual operation.

In the present system, as for a management center 1100, an office-A (12100) and an office-B (12201) are connected to the management center 1100 through the Internet 1101, and it is assumed that a user-A (12101) has such an authority that he can enter both of the office-A (12100) and the office-B (12201) and work there. The user-A (12101) works ordinarily in the office-A (12100) and executes temporary work in the office-B (12201) as a destination of a business trip. It is also assumed that in the office-B (12201) which is used at a destination of the business trip, a level of a security countermeasure is lower than that of the office-A (12100) which is generally used and a range of resources which can be disclosed for the work in the office-B (12201) should be limited to be narrower than a range which can be disclosed in the office-A (12100).

In the management center 1100 to which such two offices are connected through the Internet 1101, the management server 1700 for controlling the disclosure range of the resources is provided. The management server 1700 has therein an access control function 1900 which mainly plays a role of the access control. The access control function 1900 controls the disclosure range of the access destination resources 1200, 1300, and 1400 by applying the filtering to the switch 1500 while making the collation of the policy by using a filtering policy 12301.

The embodiment shows a situation where if the user-A (12101) makes a business trip between the office-A (12100) and the office-B (12201) as different offices and works, when he accesses the access destination resources through the same blade PC 1600 by using a same user terminal-A (12102) at both working places, the resources are disclosed in the proper disclosure range.

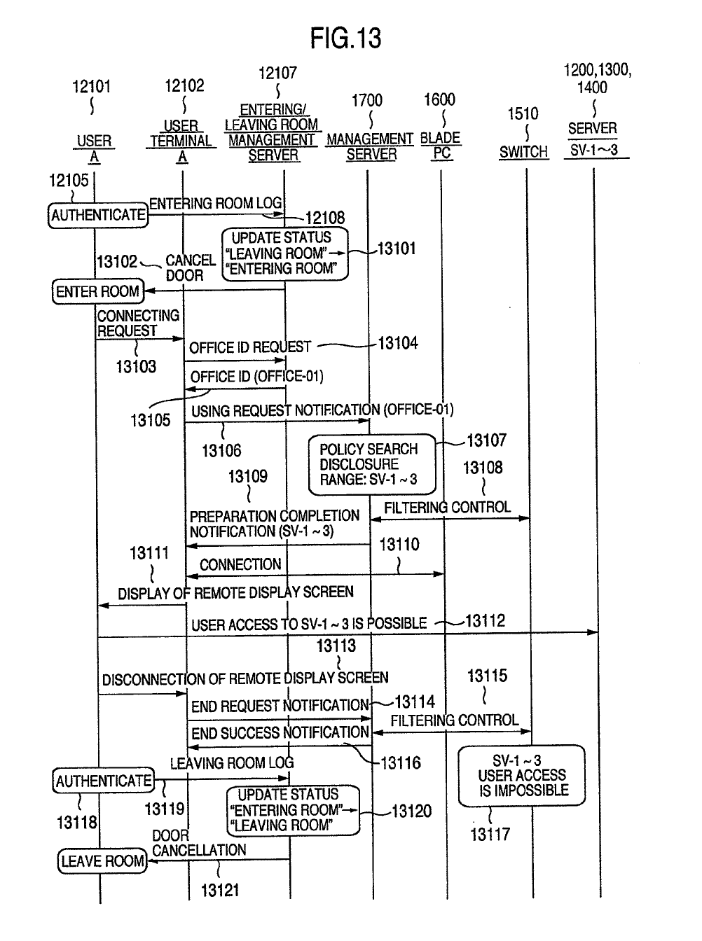

In the system constructional diagram of FIG. 12, the system operates according to a sequence diagram showing an operation outline of FIG. 13. In the office-A (12100) as an ordinary using environment, the user-A (12101) makes an authentication 12105 by using an entering/leaving room card 10103 by holding the card in front of a reader 10104. Information of the entering/leaving room card 10103 read by the reader 10104 is sent to an entering/leaving room management server 12107 (12108). Upon such sending of the information, the reader 10104 can mainly play a role so that the information is actively transmitted to the entering/leaving room management server 12107 or the entering/leaving room management server may mainly play a role so that the reader 10104 periodically and passively obtains the information from the entering/leaving room management server 12107.

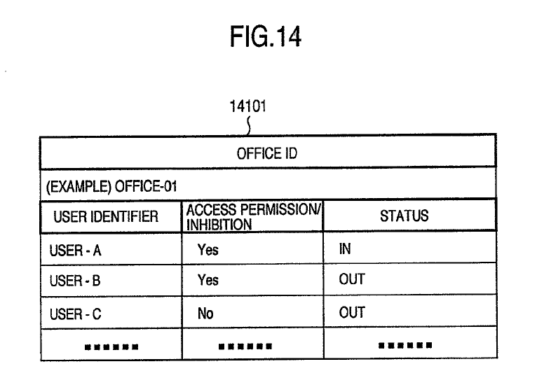

The entering/leaving room management server 12107 has a database 12106 which is managed by itself. This database has a structure 14101 shown in FIG. 14. The database has an office ID column as information common to all users in the relevant office and it is assumed that OFFICE-01 showing an office ID of the office-A has been set as an example. The database has three columns of a user identifier column, an access permission/inhibition column, and a status column as setting information of each user. An identifier for unconditionally identifying the user is set into the user identifier column. As an example, it is assumed that the user-A, user-B, and user C have been set as USER-A, USER-B, and USER-C, respectively. An identifier showing an entering/leaving room state for each user is set into the status column. The office ID column, user identifier column, and access permission/inhibition column are preliminarily set by the administrator. If there is such a request that it is intended to temporarily restrict the entering/leaving into/from the room due to some reasons for the users who have already been registered, it is unnecessary to delete and reregister the user identifiers and it is sufficient to change the access permission/inhibition information from “permission” to “inhibition” and return it to the original state upon cancelling the restriction. The status column is not manually registered by the administrator but is automatically updated by the entering/leaving room management server 12107 synchronously with the room entering/leaving of each user.

By searching the inside of the database 12106, the entering/leaving room management server 12107 which has received the information of the entering/leaving room card 10103 checks an entering/leaving room authority of the user-A (12101). If it is regarded that the user-A (12101) has the entering/leaving room authority, the status of the user is updated from “leaving the room” to “entering the room” (13101) and a lock of a door is unlocked (13102). After completion of the entering into the room, the user-A (12101) instructs a connecting request 13103 to the user terminal 12102 by pressing a physical switch of the user terminal-A (12102) or a connecting button on a display screen of the user terminal, or the like.

The user terminal 12102 which has received the connecting request 13103 requests the entering/leaving room management server 12107 to provide an office ID which has previously been allocated to the entering/leaving room management server 12107 by the administrator (hereinbelow, simply referred to as an office ID) in order to unconditionally decide the office (13104). The entering/leaving room management server 12107 makes a response including the identifier “OFFICE-01” as an office ID allocated to itself to the user terminal 12102 (13105). Subsequently, the user terminal 12102 transmits a using request notification 13106 including the office ID “OFFICE-01” to the management server 1700 provided in the management center 1100.

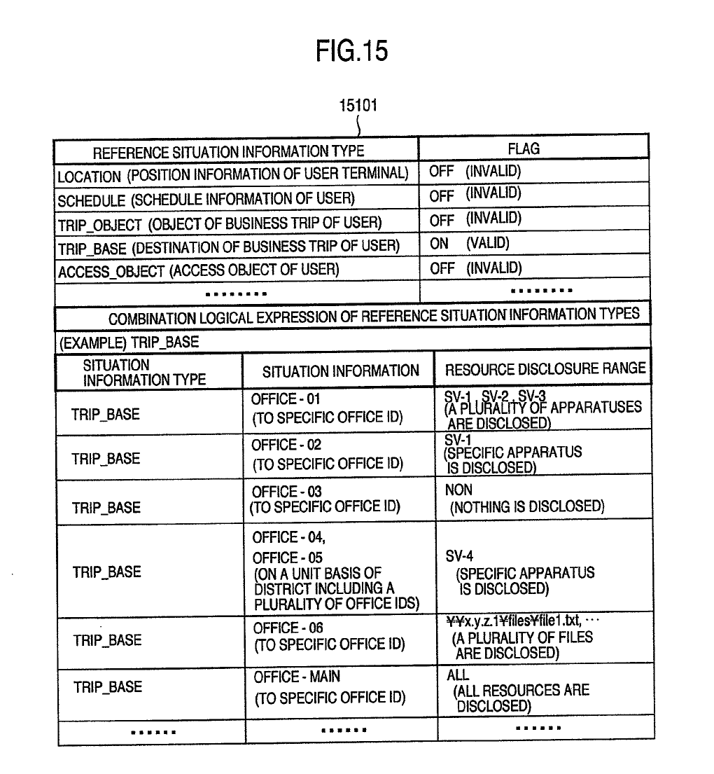

The filtering policy 12301 which is managed by the management server 1700 provided in the management center 1100 has a data structure 15101 shown in FIG. 15. Although the data structure itself is not essentially different from the data structure 1703 shown in FIG. 4, in the embodiment, it is essential that the access control in the remote site is made on the basis of information showing which one of the offices the working place is. Therefore, a setting example in which an attention is paid particularly to the office ID as a situation information type is shown as an example.

Each column in a table will be described hereinbelow.

In a reference situation information type column showing which one of a plurality of set situation information types is used as valid information, a case where only the situation information type “TRIP_BASE” showing the destination of the business trip of the user is turned ON (validated) and the others are invalidated is shown as an example. The situation information type “TRIP_BASE” is not necessarily limited to the office ID in particular so long as it is the information showing the destination of the business trip of the user. A name of each destination of the business trip or a name of a district where neighboring offices are collected may be used. It is assumed that only “TRIP_BASE” has been set in the combination logical expression column of the reference situation information type column. As setting information of each user, there are a situation information type column, a situation information column, and a resource disclosure range column. All of the situation information type columns are set to “TRIP_BASE” in common and it is assumed that the following policies have been set: a policy for disclosing a plurality of apparatuses (SV-1, SV-2, SV-3) for the specific office ID (OFFICE-01): a policy for disclosing the specific apparatus (SV-1) for a specific office ID (OFFICE-02): a policy for disclosing nothing (NON) for a specific office ID (OFFICE-03); a policy for disclosing a specific apparatus (SV-4) on a district unit basis including a plurality of office IDs (OFFICE-04, OFFICE-05): a policy for disclosing a plurality of files (¥¥x.y.z.1¥files¥file1.txt, . . . ) for a specific office ID (OFFICE-06): and a policy for disclosing all resources for a specific office ID (OFFICE-MAIN). In all of the above cases, since a grading of the resource disclosure range merely changes and the essence of the control is identical, as an explanation of specific control, only with respect to the policy for disclosing the plurality of apparatuses (SV-1, SV-2, SV-3) for the specific office ID (OFFICE-01) and the policy for disclosing the specific apparatus (SV-1) for the specific office ID (OFFICE-02) will be specifically explained here as first two policies. The management server 1700 searches for the foregoing filtering policy 12301 (13107), sets the disclosure range of the resources for the user-A (12101) to the three servers 1200, 1300, and 1400, executes the application of the filtering to the switch 1500 (13108), and opens the ports. If the application of the filtering is successful, the management server 1700 transmits a preparation completion notification 13109 showing that the preparations for access to the servers 1200, 1300, and 1400 have been completed to the user terminal 12102. The user terminal-A (12102) which has received the preparation completion notification establishes the connection to the blade PC 1600 (13110). At a point of time when the connection has been established, a remote display screen is displayed on a display screen of the user terminal-A (12102) (13111). Therefore, by using such a display as a trigger, the user-A (12101) can execute the work while accessing the resource of the servers 1200, 1300, and 1400 through the blade PC 1600 (13112).

At a point of time when the user-A (12101) has finished the work, by using a fact that the remote display screen is disconnected (13113) as a trigger, the user terminal-A (12102) transmits an end request notification 13114 to the management server 1700. The management server 1700 which has received the end request notification applies the filtering control to the switch 1500 so as to shut off the accesses to all traffics in the ports to which the blade PC 1600 is connected (13115) and transmits its result as an end success notification 13116 to the user terminal-A (12102). At this point of time, the remote display screen is disconnected on the user terminal-A (12102) and the resources in the center cannot be completely accessed (13117). Therefore, by using such timing as a trigger, the user-A (12101) tries to completely finish the work at the user terminal-A (12102) and leave the room. Upon leaving the room, the user-A (12101) makes the authentication by holding the entering/leaving room card 12103 in front of the reader 12104 (13118). At this time, in a manner similar to the case upon entering the room, the information of the entering/leaving room card 12103 is transmitted to the entering/leaving room management server 12107 (13119). If it is regarded that the user is a user having the entering/leaving room authority by searching the database 12106 in a manner similar to the case upon entering the room, the status of the present user-A (12101) on the database 12106 is updated from “entering the room” to “leaving the room” (13120). The entering/leaving room management server unlocks the lock of the door in order to allow the user to leave the room (13121). The user-A (12101) completes the leaving from the room.

The processes mentioned so far are a remote accessing procedure of the user-A (12101) in the office-A (12100).

Subsequently, a case where the same user-A (12101) has used the same user terminal-A (12102), gone to the office-B (12201) as another base, entered the room by using the same entering/leaving room card 12103, and tried to similarly make the remote connection from this location will be described.

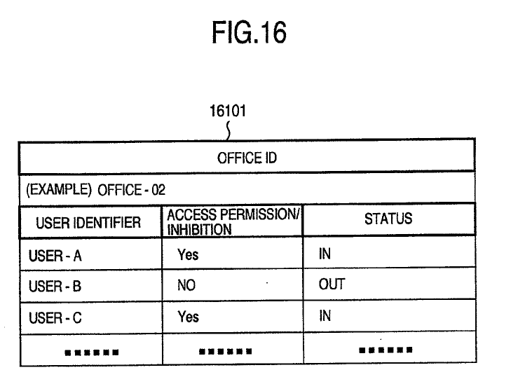

Although a reader 12202, an entering/leaving room management server 12205, and a database 12204 provided in the office-B (12201) are physically different from the reader 12104, entering/leaving room management server 12107, and database 12106 provided in the office-A (12100), respectively, their operations, data structures, and the like are identical. Therefore, an authenticating process 12203 using the entering/leaving room card 12103 is similar to the authenticating process 10205. Communication 12206 between the reader 12202 and the entering/leaving room management server 12205 is also similar to communication 12108 between the reader 12104 and the entering/leaving room management server 12107. Since it is considered that the restriction of the entering/leaving into/from the room is independently provided every office, the registration information in the database 12204 may be different or identical every office. However, in the embodiment, as individual setting to the user-A (12101), it is assumed that the user-A (12101) also has the entering/leaving room authority for the office-B (12201) in a manner similar to that for the office-A (12100). A data structure 16101 of the database 12204 is shown here in FIG. 16. This database has a user identifier column, an access permission/inhibition column, and a status column in a manner similar to the database 14101 in FIG. 14. Since the status column changes depending on the entering/leaving room state of the user at that time, it is not always identical to that in the database 14104 in FIG. 14.

Unlike the database 12106 in the office-A (12100), as an office ID as setting information which is common for all of the users regarding the office-B (12201) in the database 12204, it is assumed here that an identifier “OFFICE-02” has been set.

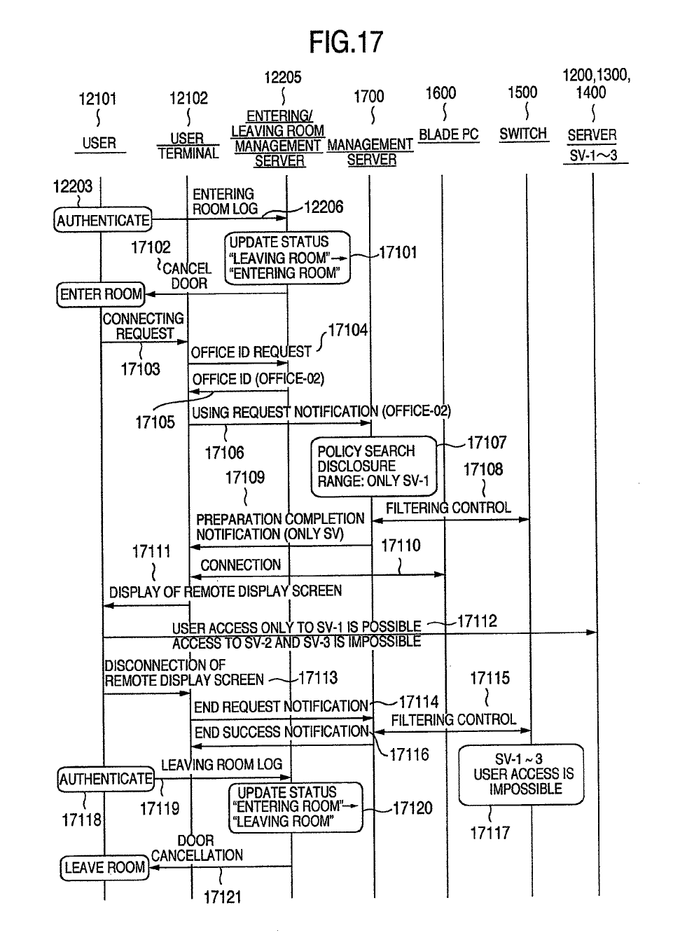

FIG. 17 is a diagram showing a sequence of the user access in the office-B (12201). The processes 12203 and 12206 and processes 17101 to 17104 and 17113 to 17121 are similar to those in FIG. 13.

In FIG. 17, as a response to a request 17104 of the office ID from the user terminal-A (12102), the entering/leaving room management server 12205 makes a response of the office ID (OFFICE-02) (17105). In a using request notification 17106, since a notification including the office ID (OFFICE-02) of the office-B (12201) is transmitted, the management server 1700 searches for the corresponding line in the filtering policy in FIG. 15, determines that only the disclosure of the server SV-1 (1200) can be permitted (17107), and makes control so as to disclose only the server SV-1 (1200) to the switch 1500 (17108). Thus, a preparation completion notification 17109, a connection 17110, and a display 17111 of the remote display screen are performed. Finally, the user-A (12101) can access only the server SV-1 (1200) and cannot access the servers SV-2 and SV-3 (1300, 1400) as other servers (17112).

As mentioned above, even if the different security policy exists every office, the user can control and provide the proper disclosure range of the access destination resources without being aware of such a fact and in a state where the security level is also held.

Although the embodiment has been shown as an example on the assumption that the management server 1700 exists, it can be realized in combination with the fifth embodiment in terms of the essence of the invention, that is, it is not always necessary that the managing function is realized on the management server 1700 but may be realized as an agent on a relay apparatus (blade PC here) of each user. In this case, with respect to the setting and change of the filtering policy, it is not always necessary that only the administrator can change it but it is assumed that the filtering policy can be set and changed by the user or can be set and changed by both of the user and the administrator.

Although the system in which the entering/leaving room card is held in front of the readers 12104 and 12202 both upon entering the room and upon leaving the room has been mentioned in the embodiment, the invention is not limited to such a system in the actual operation. Upon entering the room, it is not an object to take a log but is a main object to restrict the entering into the room and it is better to hold the card. On the contrary, upon leaving the room, it is not an object to restrict the leaving from the room but is a main object to take the log. Therefore, at the time of leaving the room, a contactless type is suitable in consideration of a troublesomeness of the user. As mentioned above, the using methods of the readers can be selectively used upon entering the room and upon leaving the room. As a method other than the entering/leaving room card, for example, there is an organism authentication using fingerprint information, vein information, iris information, or the like.

### Embodiment 7

A realizing system of the relay apparatus will be described as a seventh embodiment hereinbelow. In the invention, particularly, a realizing form of functions which are required for the relay apparatus is not limited so long as the relay apparatus can merely receive a connecting request from the remote site, establish a connection, and provide accesses to a plurality of access destination resources onto its extension line. Therefore, the relay apparatus can be provided as a physical apparatus or may be provided as a virtual apparatus. In the case of the virtual apparatus, specifically speaking, a realizing system in which a plurality of virtual machines operate on a platform called a virtual server may be used or a form of a server based computing in which a working application environment as a common resource is provided to a plurality of user spaces can be also used. In the case of the physical apparatus, it is not always necessary to use a blade PC of a rack mount type as introduced in the embodiment and a general desk top type PC may be used. A form generally called a storage centric system in which a storage apparatus or the like is connected as an external hard disk to the relay apparatus and a user environment is expanded can be also used. As another form, in the invention, it is also possible to use a system generally called a network boot system of such a form that the user terminal-A (12102) as a connecting source does not have a hard disk in its own terminal (the user terminal of such a form is called a diskless PC hereinbelow) and an operating system is loaded from a hard disk in the relay apparatus such as a blade PC 1600 or the like existing at a remote site such as a management center 1100 or the like or, similarly, from a disk existing at a remote site such as a management center 1100 or the like through the network such as an Internet 1101 or the like and is activated.

A construction in which the user cannot be directly connected to a server group or the like as an access destination resource from the remote site but has to be temporarily connected through the relay apparatus such as a blade PC or the like can be used. A construction in which the user can directly access the access destination resource without an intervention of the relay apparatus can be also used. In the case of the construction in which the user can directly access the access destination resource without an intervention of the relay apparatus, since the user access cannot be monitored nor managed by the agent existing in the relay apparatus, by holding this agent in the access destination resource and communicating with the management server 1700, a path for the user access is provided. A plurality of agents can be provided in the access destination resource for a plurality of user accesses or requests from a plurality of users can be also received by one agent. In any of the above cases, no influence is exercised on the fundamental processing sequence of the invention.

### Embodiment 8

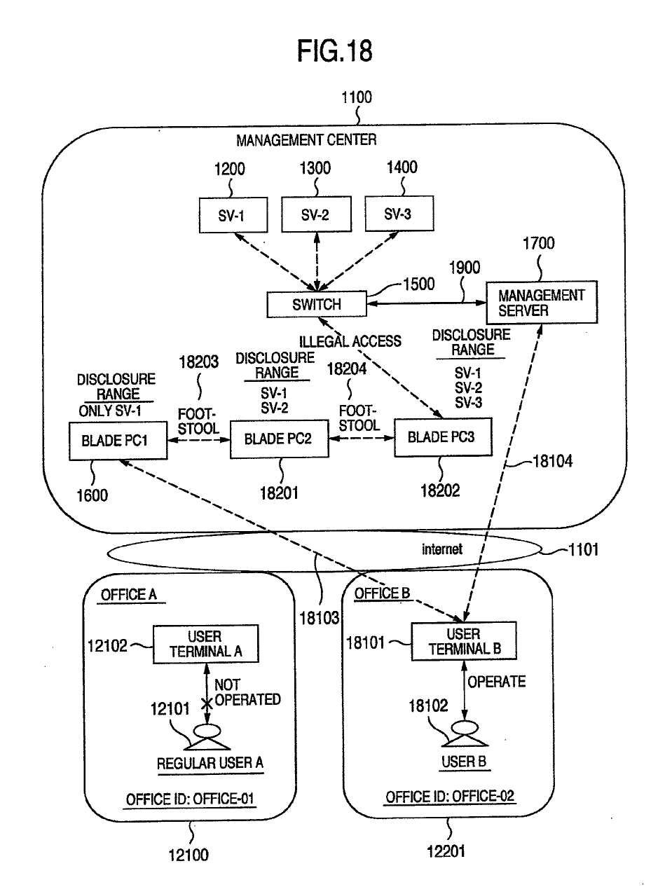

An example showing another effect is shown hereinbelow as an eighth embodiment. It is an essence of the invention according to the embodiments described above that the information in the management center existing at the remote site is disclosed to the user within a range suitable for its situation in consideration of the user terminal existing at the destination or a situation where the user exists. By this mechanism, further, in the actual operation, a secondary effect is obtained in view of the security for accesses of multi-stages. A fundamental construction in the embodiment is shown in FIG. 18. A wording “multi-stages” does not denote serial multi-stages between the server serving as a final target of the access destination resource when seen from the user and the user but denotes that such parallel accesses that make a connection between the blade PCs are made between the blade PC as one of the relay apparatuses and the user.

FIG. 18 shows a system obtained by generalizing the system construction of FIG. 12 on the assumption that three blade PCs of the blade PC1 (1600), a blade PC2 (18201), and a blade PC3 (18202) are provided in order to enclose a plurality of users. With respect to each blade PC, it is assumed that use of one user has been allocated per blade PC.

In FIG. 18, it is assumed that the regular user-A (12101) does not operate the user terminal-A (12102) but is in a state where it is not connected to the present system. In FIG. 18, although the user-A (12101) exists in the office-A (12100), the existing location of the user-A (12101) is not limited in particular so long as it does not access the system.

At this time, a case where a user-B (12102) tries to connect to the present system is considered. The user-B (12102) may be either a regular user or an illegal user. That is, there may be a case where the regular user registered in the filtering policy 1703 which is managed by the management server 1700 in the management center 1100 explicitly inquires of the management server 1700, is formally connected to its own blade PC, and thereafter, makes a connection among the different blade PCs in a multi-stage manner so as to be connected to them, thereby obtaining the access authority in the illegal information disclosure range. There may be a case where the (unknown) illegal user which is not originally registered in the filtering policy 1703 which is managed by the management server 1700 falsifies the situation information, is connected to an arbitrary blade, uses a footstool in a multi-stage manner by using such a blade as a base, thereby obtaining the access authority in the illegal information disclosure range. A multistage access of the access control function which is valid to both of the above cases is provided. In the embodiment, it is assumed that among various cases as mentioned above, an attention is paid to such an illegal access that the regular user tries to access also unpermitted resources over the range which can be accessed by himself.

Originally, the definition of the filtering policy 1703 is a definition which is not allocated to the blade PCs 1600, 18201, and 18202 but is allocated to the situation information. Even if the user terminal of the accessing source is added to such a condition, the blade PC as a relay apparatus is not included. Therefore, although the disclosure range of the information is not preliminarily directly allocated to the blade PC, in the case where the blade PC which is used by the user has fixedly been allocated, that is, in the case where the relay apparatus which is ordinarily used by the regular user A (12100) has fixedly been determined to be the blade PC3 (18202) or the like, access control corresponding to such control that the information disclosure range is indirectly fixedly allocated to the blade PC at a point of time is made when the information disclosure range to each user has been decided.

As a prerequisite in the embodiment, the resource disclosure ranges allocated to the blade PCs are different. The blade PC1 (1600) can disclose only the server SV-1 (1200), the blade PC2 (18201) can disclose the servers SV-1 (1200) and SV-2 (1300), and the blade PC3 (18202) can disclose all of the servers SV-1, SV-2, and SV-3 (1200, 1300, 1400), respectively. It is assumed that the blade PC3 (18202) has been allocated to the user-A (12101) and the blade PC1 (1600) has been allocated to the user-B (18101).

First, the user-B (18101) transmits a using request notification 18104 to the management server 1700, establishes the connection to the blade PC1 as an authority which has preliminarily been given to himself, and at the same time, obtains the access right to the server SV-1 (1200). However, in this state, he cannot access the other servers.

Therefore, the user-B (18101) makes such an illegal access to make a connection to the blade PCs provided for the other users and further enlarge the access range. In FIG. 18, the user-B (18102) is temporarily connected from a user terminal-B (18101) to the blade PC1 (1600) through the Internet 1101 (refer to 18103), is further connected from the blade PC1 (1600) to the blade PC2 (18201), is connected from the blade PC2 (18201) to the blade PC (18202). In this manner, the user-B successively repeats the connection (refer to 18203, 18204) and finally has the access authority to all of the servers. The user-B tries to access the server over the permitted range through the switch 1500 from the blade PC which is ought to have ordinarily been used by the user-A (12101). However, according to the invention, the illegal access cannot be made because of the following two points: a point that at the time of the user access, there is a prescribed sequence and if a connecting procedure is not executed according to such a sequence, the access control to the switch is not released, and the servers in the management center cannot be accessed; and a point that the access control is made by using true connection information existing at the destination instead of connecting source information just before the connection.

### Embodiment 9

Subsequently, an expansion of the situation information will be described as a ninth embodiment. In the first to eighth embodiments, the method of the access control based on the situation information regarding a situation where the user at his destination exists truly as situation information has mainly been described. However, since the above situation information varies depending on a situation where each user exists, it is difficult to set a unified policy. There is such a tendency that operation costs for the administrator rise with an increase in the number of users. A case of applying the filtering policies in a lump to a plurality of users having the same orientation in order to solve such a problem is shown in the embodiment.

Also in the first to eighth embodiments, by defining the filtering policies by the range of IP addresses, a network unit, a base unit, and an access object, the costs can be reduced as compared with such work that the individual IP address is simply defined every user. According to such work, it is necessary to previously grasp a network construction of the whole system or it is necessary to successively be aware of the access object of each user and information at the working base which changes dynamically.

In the embodiment, a method of access control based on information which does not change even if the IP address, access object, and the like of the working base or the accessing source change due to the attribute information which is always annexed to the user himself will now be described.

In the situation information, the schedule information, object of the business trip, the access object to the resources, and the like can be mentioned besides the information which is directly concerned with the position information as shown in FIG. 4 in the first embodiment. Secondary situation information associated with such direct situation information is called meta situation information.

Although the foregoing meta situation information can be also set on a user unit basis, in the case of the same business work or the same department or project or in the case where an office organization of the same level is provided, a tendency that a similar filtering policy is set is large. In order to realize high efficiency of the actual operation by using such a tendency, it is assumed that the access control based on office organization information and a work type can be also similarly made. To realize the embodiment, it is necessary that the following two conditions are satisfied. One of them is that the above two information, that is, the office organization information and the work type are included in the filtering policy. The other one is that when the user terminal transmits the using request notification to the management server, a packet including the information such as foregoing office organization information and work type is transmitted or, in a manner similar to the first embodiment, only the user identifier is transmitted, the management server side in the management center which has received the user identifier has a correspondence relation (table) between the user identifier and the meta situation information, and the management server searches this table, thereby making the access control. The above two points are necessary.

As effects of the embodiment, there are the following effects: since the foregoing meta situation information is used as information which does not frequently change for a certain predetermined period of time even if the situation where the user works changes, once such information is registered, the costs for the administrator or the user which are caused by the frequent information updating can be reduced; and since the information such as office organization information, work type, and the like as meta situation information is generally often managed by the existing management server, by associating with such a management server, there is no need to be aware of the maintenance costs. When the security policy is changed, by changing only the meta situation information, the access control of all of the users concerning therewith can be changed in a lump.

When using the meta situation information introduced in the embodiment, it can be also used in combination with situation information for narrowing the position information in the access control. As a realizing method, it is sufficient to add conditions of the situation information, conditions of the meta situation information, and logical expressions which instruct their using methods to a file of the filtering policies in a manner similar to the first embodiment. Thus, such a filtering policy of a telescopic format that the access control of each user is individually set in addition to the access control of the organization unit can be defined.

### Embodiment 10

The tenth embodiment will now be shown.

Although the multi-stage access of the user has already been mentioned in the eighth embodiment, in the eighth embodiment, the case where an attention is paid, particularly, to the illegal access by the regular user or the illegal user has been described, and it is not related to a multi-stage access in the regular access in the normal operation.

This embodiment presumes a using method whereby, instead of a footstool-like using method, a target access destination resource is accessed by making a connection to the relay apparatuses in a multi-stage manner as a regular access path in the normal operation. Also in this case, it is shown that the information disclosure in the proper range is held for the user terminal at the destination.

As a difference from the eighth embodiment, although the user makes a connection to the relay apparatuses of the other users in the eighth embodiment, according to the present embodiment, a using method whereby the user makes a connection to a plurality of relay apparatuses which have previously been allocated to the user instead of the relay apparatuses of the other users.

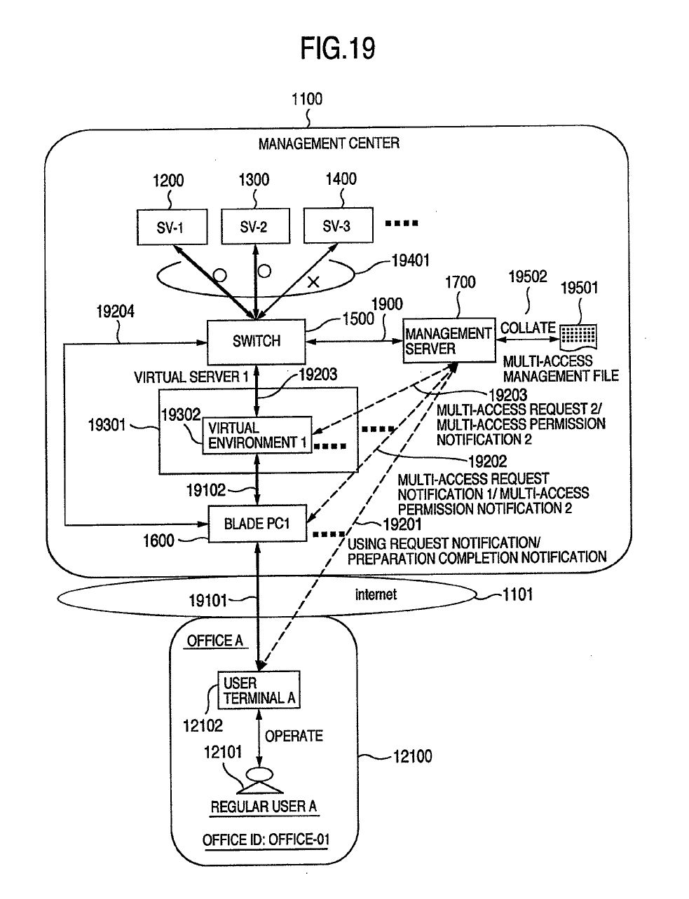

FIG. 19 shows a fundamental system construction of the embodiment.

The management center 1100 and the office-A (12100) are connected by the Internet 1101 (refer to 19101). A virtual server-1 (19301) and the blade PC1 (1600) are connected in the management center 1100 through the switch 1500 (refer to 19102, 19203, 19204). In this instance, the virtual server may be a server for making a plurality of virtual machines operative on a dedicated platform and providing a user individual environment or may be a server of a server based computing in which user individual environments are provided and a working application environment as a common resource is provided for each user individual environment. A virtual environment-1 (19302) as one of the user individual environments is operating on the virtual server (19301). The user can use the virtual environment-1 (19302) in a manner similar to that for a working environment such as blade PC1 (1600), user terminal-A (12102), or ordinary physical PC like a blade PC1 (1600).

The accessing procedure will now be described. In the embodiment, it is assumed that the security policy which is managed by the management server 1700 has been set in such a manner that the resources which can be accessed by the user-1 (12101) from the office-A (12100) are limited only to the two servers 1200 and 1300 among the three server resources 1200, 1300, and 1400 in FIG. 19 (19401). First, the user-A (12101) transmits a using request notification to the management server 1700 by using the user terminal-A (12102), thereby receiving a preparation completion notification as a response (19201). At this point of time, the user-A (12101) can access the blade PC1 (1600) from the user terminal-A (12102) and, at the same time, can obtain an access authority from the blade PC1 (1600) to the servers 1200 and 1300. However, it is presumed that a case where the user-A (12101) has a plurality of relay apparatuses on the present system, constructs an environment by dividing the relay apparatuses for every use, and uses them. As one of such examples, in the present system, in the case of executing such work that an environment on the blade PC1 (1600) is used as an ordinary working environment, the virtual environment-1 (19302) is used as an experiment environment, experiments are executed with reference to manual existing on the servers 1200 and 1300 on the virtual environment-1 (19302), their experiment results are totalized and analyzed on the blade PC1 (1600), and the like, work of high working efficiency can be performed if not only the data of the servers 1200 and 1300 can be referred to from the blade PC1 (1600) as a working environment but also the data of the servers 1200 and 1300 can be referred to from the virtual environment-1 (19302).

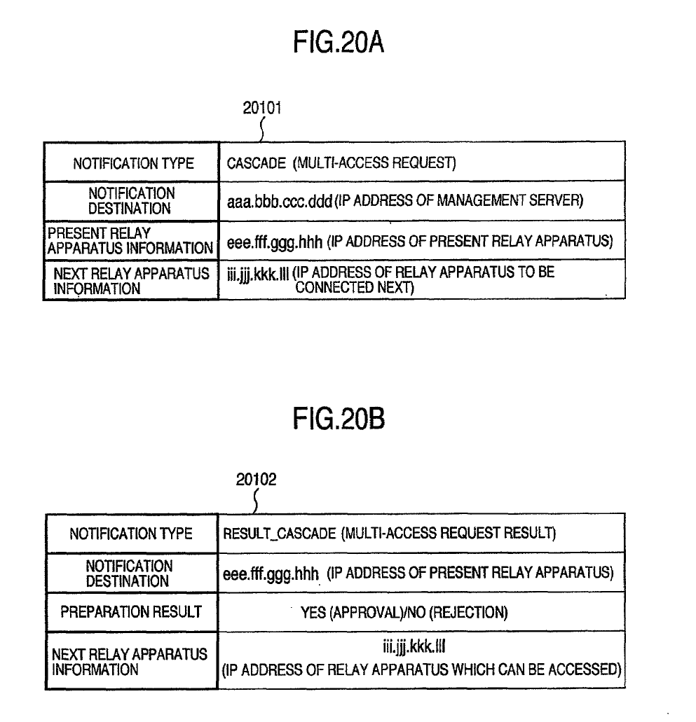

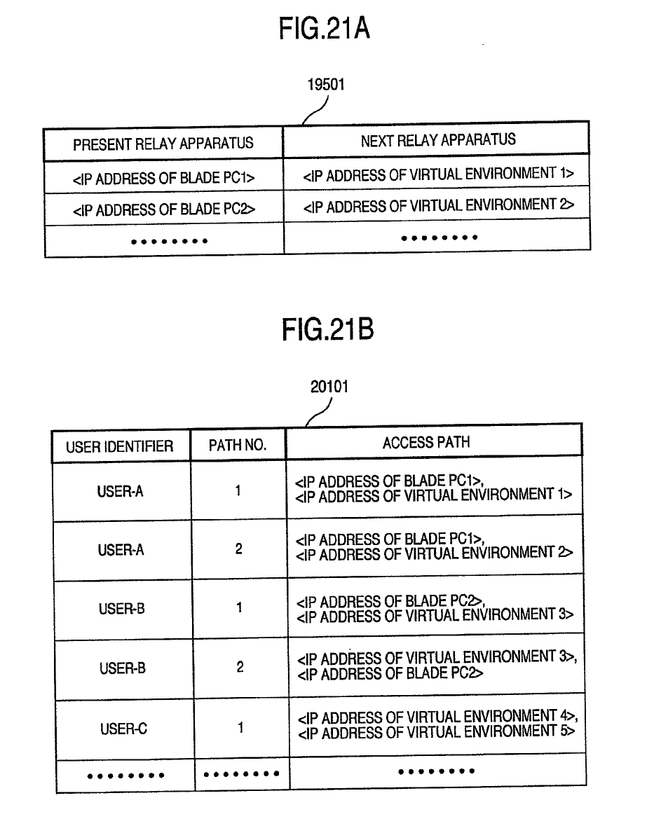

Therefore, the user-A (12101) transmits a multi-access request notification 19202 to the management server 1700 from the blade PC1 (1600) as a connection destination. Data structures of multi-access request notification 19202 and 19203 are like a data structure 20101 shown in FIG. 20A. A packet in which “CASCADE” is set as an identifier showing the multi-access request into a notification type column, the management server 1700 is set as a transmission destination of such a notification, and information of the IP address of the relay apparatus existing at present and the IP address of the relay apparatus to be connected next has been set as information showing a pair of connection is transmitted. The management server 1700 which has received the packet refers to a multi-access management file 19501 as shown in FIG. 21A and searches it to see if a pair of the relay apparatus serving as a requesting source and the next relay apparatus serving as a requesting destination has been defined in the multi-access management file 19501 as a pair which has previously been permitted. If it has already been defined, the management server 1700 applies access control for realizing such an access to the switch 1500 (1900) and transmits a multi-access permission notification to the present relay apparatus as a requesting source (refer to 19502). If the above pair is not defined in the multi-access management file 19501, it is rejected as an illegal request which is not permitted.

A data structure of the response packet which is transmitted to the present relay apparatus has a structure as shown at 20102 in FIG. 20B. An identifier “RESULT_CASCADE” indicative of the response to the multi-access request notification is set as a notification type. Information of the IP address which has been set as a present relay apparatus by the request notification is set into a notification destination. “YES/NO” showing an approval/rejection for/to the request for the above relay connection is set into a preparation result column. Finally, the IP address of the relay apparatus of the connection destination serving as a target of the approval or rejection is set into a next relay apparatus information column.

Although a situation in which the relay apparatus through which the user subsequently wants to pass can be explicitly grasped by the multi-access request notification by the present relay apparatus has been shown as an example in the embodiment, the invention is not limited to it in the actual operation but can use the following method. The multi-access request notification showing a fact that the user merely wants to perform the multi-access and excluding information showing the relay apparatus through which the user subsequently wants to pass is transmitted once from the present relay apparatus to the management server 1700, the management server 1700 which has received such a notification makes a list of the relay apparatuses which can be multi-accessed by the user or relay apparatus which has transmitted such a notification by referring to the multi-access management file 19501 and transmits it as a response to the present relay apparatus, the present relay apparatus selects the relay apparatus suitable for the next work from the list of the relay apparatuses and transmits a deciding request for the multi-access use again to the management server 1700, if the relay apparatus included in the deciding request is included in the list of the relay apparatuses transmitted as a response in the process at the front stage, the management server 1700 determines that the multi-access is the regular multi-access, and applies the access control for permitting the access to the next relay apparatus to the switch 1500 (1900). The latter method is considered to be a using method which is effective to the case where the number of stages of the relay apparatuses is large, the case where the uses are complicated, the case where the access path which can be relayed is limited, or the like.

Although the example in which the address of the present relay apparatus is set as information of the requesting source the data structure 19501 of the multi-access management file in FIGS. 20A and 20B has been mentioned in the embodiment, the invention is not limited to it. As shown in the data structure 20101 in FIG. 21B, it is possible to use a packet of such a data structure that a plurality of path numbers are allocated to one user by using the user identifier as a key and a definition including connecting order of the multi-accessible relay apparatuses is set for each path number. For example, in the data structure 19501, two paths of the multi-access have previously been allocated to the user-A and it is shown that the multi-access to the virtual environment-1 (19302) from the blade PC1 (1600) and the multi-access to the virtual environment-2 from the blade PC1 (1600) are permitted.

In the holding methods 19501 and 20101 of the two kinds of multi-access management files, 19501 is effective in the case where the relay path is not so complicated, the case where one relay apparatus is shared by a plurality of users, or the like, and 20101 is effective in the case where the relay path is complicated, the case where the user which can use one relay apparatus is limited, the case where the user wants to integratedly manage not only the connecting relation with the relay apparatus just before but also the access path from the first relay apparatus to the last relay apparatus also including the accessing order, or the like.

The embodiment is not limited to the case where the resource is accessed at an end point of making the connection by the multi-access but has been described on the assumption that the resource can be also accessed at any time from the relay apparatus on the way of the path. However, it is not always necessary to individually prepare the filtering policy for all of the relay apparatuses. So long as the situation (situation information) of the accessing source is identical, the disclosure range should be identical whatever the relay apparatuses exist on the way of the path or through which machine the data passes. It is assumed that the management server always refers to and applies the same filtering policy so long as a request from the relay apparatus which has been registered so that the user uses it.

Therefore, for the present situation information of the user-A (12101), the management server 1700 decides that he can connect to the virtual environment-l (19302), so that the user-A (12101) establishes the connection to the virtual environment 19302 as a next connection destination from the blade PC 1600.

At this point of time, the user-A (12101) can also directly access the servers 1200 and 1300 through the blade PC1 (1600), execute work on the virtual environment-1 (19302) through the blade PC 1600, or access the servers 1200, 1300, and 1400 from the virtual environment-1 (19302). Although not shown as an example in FIG. 19, he can also execute work through the relay apparatus further for the next multi-access. There is no limitation in the number of relay apparatuses existing between the servers 1200, 1300, and 1400 as final access destinations and the user terminal-A (12102) as a true accessing source. An arbitrary number of relay apparatuses may exist or a system of a form in which the user terminal is directly connected to the servers 1200, 1300, and 1400 without intervention of the relay apparatus may be constructed in the case of passing through the relay apparatus for the further next access from the virtual environment-1 (19302), in a manner similar to the case of performing the multi-access from the blade PC1 (1600) to the virtual environment-1 (19302), by transmitting the multi-access request-2 to the management server 1700 and receiving the multi-access permission notification-2 as a permission for it, the user can pass through the relay apparatus at the next stage step by step (19203).

Subsequently, in order to connect to the servers 1200, 1300, and 1400 as final connection destinations through the blade PC1 (1600) and the virtual environment-1 (19302), the user-A (12101) transmits the multi-access request-2 of the second time to the management server 1700. If it is possible to confirm that such a request has been set as a permissible connection destination in the multi-access management files 19501 to 20101, the management server 1700 receives the multi-access permission notification as a response to it (19203). At this point of time, the user-A (12101) can obtain an access authority for the servers 1200, 1300, and 1400 through the blade PC1 (1600), virtual environment-l (19302), and switch 1500.

It is also assumed that even in the case of connecting to the access destination resource through a plurality of relay apparatuses, so long as the situation information of the true accessing source is not changed, the range of the information to be disclosed or the range of the information which has not to be disclosed is identical in principle.

However, as an applying and using method of the embodiment, in the case where an office environment is set on the relay apparatus of the first stage, an experiment environment is set on the relay apparatus of the second stage, and the work is executed while allowing those environments to coexist, such a request that the user wants to change the range of the accessible information in dependence on the office environment and the experiment environment. In such a case, there may be such a mechanism that a column in which the kinds, use objects, and the like of the relay apparatuses can be defined is provided in the table of the filtering policy, and even for the connection in which the situation information of the true accessing source is identical, by referring to this item, the management server 1700 dynamically controls the range of the information which can be disclosed in accordance with the relay apparatus from which the connection to the target access destination resource is tried.

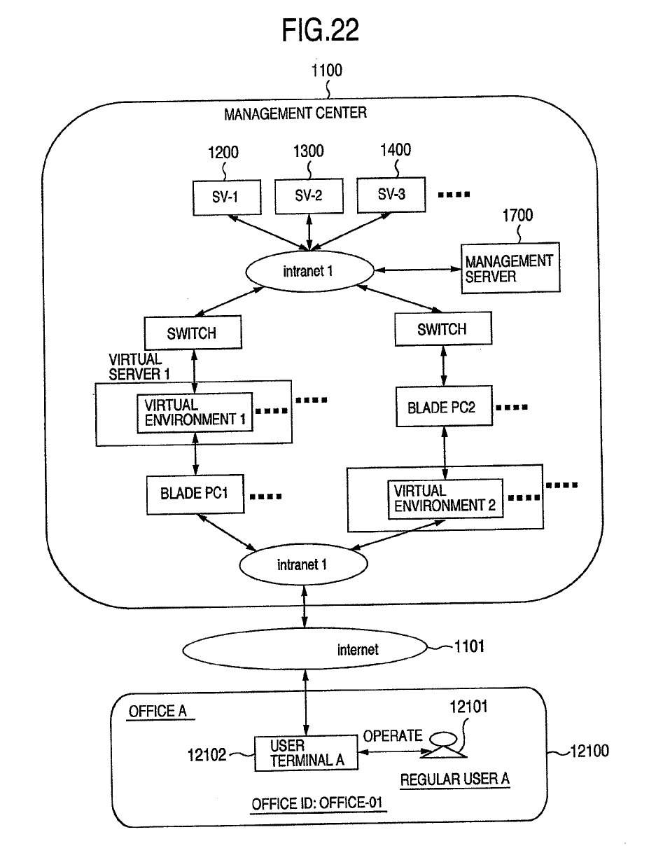

Although the virtual environment has been presumed as a second relay apparatus in the embodiment, an opposite construction, that is, a system construction in which the first relay apparatus is a virtual environment and the second relay apparatus is the blade PC can be also presumed. In this case, the kinds and order of the intervening apparatuses change merely, the essential control system of the present patent is not influenced, it is possible to cope with such a situation by the same function. In the case where the virtual environment is allocated as an office work use to the first relay apparatus and the blade PC is allocated as an experiment use to the second relay apparatus, as its system characteristics, the system has such characteristics that in the case of executing various experiments, there is a risk of causing an unexpected situation as a result of them, its influence remains as an influence on the relevant user and is not exercised on other users. However, although the influence on the other users can be suppressed, since it is unadaptable to specifications of an experiment machine, in order to execute experiments of large variations, a using method whereby the above two system constructions exist mixedly, that is, a system construction of a hybrid type as shown in FIG. 22 can be also presumed. As mentioned above, in the present system, it is also possible to cope with such a situation by substantially the same processing flow as that in the embodiment.

### Embodiment 11

A maintenance function will now be described as an eleventh embodiment.

The function of inspecting whether or not there is a logical contradiction in the filtering policy 1703 for a plurality of situation information has already been mentioned in the fourth embodiment.

The target of the logical contradiction inspected in the fourth embodiment is the description contents themselves of the filtering policy. In the actual operation, in addition to this inspection, further, a function of inspecting whether or not there is a contradiction between the logical filtering policy and the physical actual resource indicated by the filtering policy is necessary.

It is assumed that the present system has the following three functions on the basis of a viewpoint of maintenance work by the operation administrator or the user. Although it is assumed that the access control function 1702 which the management server 1700 has plays a role of those functions, particularly, a setting location is not limited so long as it is a location where the filtering policy 1703 and the servers 1200, 1300, and 1400 as physical resources can be accessed.

As a first maintenance function, the system has a function in which in the case where an access destination resource has been added, that is, in the case where a server, a folder, a file, a network, and the like have been added, the administrator or the user is notified of such a change, thereby informing that a new condition can be added to the filtering policy 1703 in the future. By receiving such a notification, the administrator or the user has an opportunity of discriminating about the necessity of the addition of a filtering policy. If it is necessary, by adding the filtering policy, the occurrence of an idle resource can be suppressed to the minimum.

As a second maintenance function, the system has a function in which in the case where the access destination resource has been changed, that is, in the case where a migration of the server, folder, file, network, and the like have been executed, for example, in the case where although storage information of the server is identical, the user has changed the server to a new server and the IP address and the server name have been changed, or the like, the IP address and the server name of the relevant line in the filtering policy 1703 are automatically corrected.

As a third maintenance function, the system has a function in which in the case where the access destination resource has been deleted, that is, in the case where the server, folder, file, network, and the like have been deleted, such a change is fed back to the filtering policy 1703. As a method of performing the feedback, it is possible to use any one of a method whereby the filtering policy 1703 is searched and, when the relevant line is found, the relevant line itself is deleted, a method whereby the relevant line is left and the mode is changed to an access impossible state, and a method whereby the relevant line is simply used as a comment line and is not used as information for control.

The functions and actions regarding the addition, change, and deletion of the access destination resource for the present system have been mentioned in the above description. Subsequently, an agent function necessary as a trigger for allowing the present action to be activated will be described.

It is assumed that in order to realize the first to third maintenance functions in the embodiment, a resource management and a state monitoring of the access destination resource are made by software agent. When an apparatus as an access destination resource is newly introduced to the system, the administrator or the user certainly executes such an operation as to install the above software agent (hereinbelow, called a resource management agent).

The resource management agent has the following five functions.

As a first function, when the resource management agent is installed in order to initially introduce the machine, the resource management agent transmits a machine addition notification including machine identification information (resource management ID, IP address, subnet mask, MAC address, host name, and the like), machine specification information (CPU type, CPU processing speed, disk capacity, memory capacity, network band, and the like), and further, management information (installation year/month/date, installer, apparatus administrator, and the like) as information peculiar to the machine of an installing destination to the management server 1700. In the information included in such a notification, the resource management ID is information which is uniquely managed by the resource management agent and is an identifier which is unique in the system and is automatically collected by the installer of the resource management agent and the management server 1700 in an interlocking relational manner when the administrator or the user installs the resource management agent. In order to assure such a uniqueness, the resource management agent applies for an issuance of the resource management ID to the management server 1700 provided in the present system. The management server 1700 records a list of the resource IDs which have been issued to the resource management agent provided in the present system and which are being used at present into a file, a database, or the like, thereby managing them. The management server 1700 which has received the application for the issuance of the resource management ID searches for the resource management IDs managed therein, forms a new resource management ID so as not to be overlapped with the existing resource management IDs, and issues the new resource management ID to the resource management agent.

As a second function, if the folder, file, network interface, and the like have been added after the resource management agent was installed, the resource management agent transmits a resource additional notice in the machine which includes the added folder name, file name, and network interface name (and number) to the management server 1700. At a point of time when the resource additional notice in the machine is received, the management server 1700 notifies the administrator or the user that a definition of the relevant resource can be added to the filtering policy 1703, as a message of a readable form such as pop-up message, E-mail, or the like.

Although the storage information (logical resource) in the server does not change, if the server (physical resource) in which the storage information has been stored changes, for example, in the migration or the like of the server associated with an increase or modification of the system, the management server 1700 is notified that by reallocating the set resource management ID to the resource management agent, it is particularly unnecessary to correct the filtering policy although the new physical resource has been added. Specifically speaking, when the data is moved from the server 1200 to the server 1300, the resource management agent is previously installed into both of the servers 1200 and 1300. After the data on the server 1200 was moved to the server 1300, an application for the migration is made to the management server 1700 from the resource management agent on the server 1200. It is now assumed that the management server 1700 has an authority of the reference, change, deletion, and the like for the resource management ID set in the resource management agent provided in the system. The IP address and the resource management ID of the server serving as a migration source and the IP address and the resource management ID of the migration destination are included in the packet of the migration application. The management server 1700 which has received such an application updates the resource management ID set in the resource management agent of the server 1200 serving as a migration source (hereinbelow, such an ID is called an old resource management ID) to a new resource management ID and, thereafter, instantaneously updates the resource management ID of the server 1300 of the migration destination to the old resource management ID. Thus, when seen from the user, it is not particularly necessary to be aware of the fact that the migration of the physical server has been made and it is possible to connect in a manner similar to the conventional manner and to maintain business continuity. When seen from the administrator, only the resource management information can be updated without particularly changing the filtering policy.

As a third function, if the folder, file, network interface, and the like have been changed (edited) after the resource management agent was installed, the resource management agent transmits a resource change notice in the machine which includes the edited folder name, file name, and network interface name (and number) to the management server 1700. At a point of time when the resource change notice in the machine is received, the management server 1700 reflects a definition of the relevant resource to the filtering policy 1703 and notifies the administrator or the user that it has been reflected, as a message of a readable form such as pop-up message, E-mail, or the like. It is possible to presume various results such as case where although the name of the resource has been changed by the change in resource as mentioned above, its substance is not changed, case where although the name of the resource is identical, its substance has been changed, case where the name of the resource and its substance have been changed, case where although the edition has been performed, the data is returned to the original data, and the like. In any case, there is a possibility that by the resource change, a security level which the resource itself has is changed from that at a point of time when the security policy 1703 has initially been set. For convenience of the operation, when the change is performed to the resource as mentioned above, not only it is reflected to the definition of the filtering policy but also in consideration of the possibility of the change in the security level, the administrator or the user is notified of such a notification as to promote the settlement of the policy again, as a message of a readable format such as pop-up message, E-mail, or the like.

As a fourth function, if the folder, file, network interface, and the like have been deleted after the resource management agent was installed, the resource management agent transmits a resource deletion notice in the machine which includes the deleted folder name, file name, and network interface name (and number) to the management server 1700. At a point of time when the resource deletion notice in the machine is received, the management server 1700 removes the definition of the relevant resource from the filtering policy 1703 and notifies the administrator or the user that it has been deleted, as a message of a readable form such as pop-up message, E-mail, or the like.

As a fifth function, when the resource management agent is uninstalled in order to remove the machine from the system, the resource management agent transmits a machine deletion notification including the machine identification information (resource management ID, IP address, subnet mask, MAC address, host name, and the like) and the management information (uninstallation year/month/date, uninstaller, apparatus administrator, and the like) as information peculiar to the uninstalling machine to the management server 1700. In order to assure consistency of the resource management ID, at a point of time when the machine deletion notification is received, the management server 1700 deletes the relevant resource management ID from the list of the resource IDs mentioned above. Thus, it is possible to previously avoid such a fault that although the user tried to access the server which can be accessed, the server of the access destination cannot be accessed because it has already been abolished, or the like. Further, for the resource which has received the notification, the management server 1700 feeds back the deletion of the resource to the filtering policy 1703 by any of the following means which have previously been made by the administrator or the user: means whereby the filtering policy 1703 is searched and at a point of time when the relevant line has been found, the relevant line itself is deleted; means whereby the relevant line is left and the accessing mode is changed to “access impossible”; and means whereby the relevant line is merely set to a comment line and is set to the line which is not the information for control.

### Embodiment 12

Subsequently, as a twelfth embodiment, a using method for applying it which copes with a mobile system will be shown as an example.

In the first embodiment, as a fundamental system construction of the invention, the embodiment in which the system can be independently operated only by a company's own infrastructure has been mentioned. However, it is the present situation that there are a variety of access forms of the user and it is not always possible to cope with them only by the company's own infrastructure. For example, although it is a main purpose of the invention that the range of the information which is disclosed to the user is dynamically controlled according to a situation of a destination, in the first embodiment, the discrimination about such a situation is made by using timing when the using request notification 1902 from the user has been received as a trigger. However, first, after the using request notification 1902 was transmitted and the proper information disclosure range thereto was decided, the user does not always move his location. Therefore, a possibility that the information disclosure range which has been decided once is not the proper disclosure range already at the next moving location is considered.

Therefore, in order to allow the user to always control the proper information disclosure range and assure the access path to the resource for the user at arbitrary timing even while moving, in the first embodiment, it is assumed that the present system has the following two functions.

The first is a real-time detection of the present position and the second is an automatic reconnection based on the detected position information.

As a real-time detecting method of the present position, its means is not particularly limited so long as it is a method whereby the position (coordinates) information can be obtained at a grading necessary for making the access control. For example, the user terminal 1800 itself may have a GPS (Global Positioning System; hereinbelow, called a GPS) function and periodically transmit the position information to the management server 1700. In the user terminal 1800, only when a detection result of the position information indicates that the user was moved exceeding a threshold value as a range which has been preset as a definition of the information disclosure range, the result may be transmitted to the management server 1700. Even if the user terminal 1800 itself does not have the GPS function therein, it is also possible to use a method whereby the user cooperates with a business company of Telecommunications (generally called a carrier) which provides the path of the Internet 1101 intervening between the user terminal 1800 and the management server 1700 and receives an offer of information of an access point, thereby indirectly knowing the position information. The last method is a method which can be realized because the position of the access point can be physically specified.

Subsequently, as an automatic reconnecting method based on the detected position information, the connecting sequence shown in FIG. 5 is executed again by transmitting the using request notification 1902 again to the management server 1700 by using a change (movement) of the detected position information as a trigger. Since a change other than a difference of the situation information including the position information does not exist between the first connecting sequence and the connecting sequence which occurred by the movement after the second time, the discrimination by the administrator or the user does not need to newly occur in particular and the connection can be started in a manner similar to the first embodiment. Since the reconnecting process is executed on the background, when seen from the user, particularly, the user is not aware of the disconnection and the reconnection and the business continuity and the usability are not deteriorated.

With respect to the reconnecting process, a function of discriminating whether the disconnection has been made due to the movement or fault or the disconnection has been made due to the end of the work of the user is necessary. If such a function does not exist, for example, there is a possibility of occurrence of such a problem that although the user merely moved in a state where the work can be performed without a fault, such a state is erroneously recognized as a work end, so that the automatic reconnection is not executed, or on the contrary, in spite of the fact that the work was normally finished, the connection is freely recovered while the user himself leaves his seat. Therefore, in the embodiment, it is assumed that a difference between the disconnection due to the movement or fault and the explicit end of the work is discriminated based on the presence or absence of the reception of an end request notification S9 shown in FIG. 5. If a session was disconnected in spite of the fact that the management server 1700 does not receive the end request notification S9 from the user terminal 1800, the management server 1700 determines it as a temporary disconnection due to the movement of the user or the fault and executes the automatic reconnection. On the contrary, if the session was disconnected in the state where the management server 1700 had already received the end request notification S9 from the user terminal 1800, the management server 1700 determines that there is an explicit work end intension by the user, and does not execute the automatic reconnection in order to also assure the security while the user himself is absent.

### Embodiment 13

Subsequently, as a thirteenth embodiment, a function expansion of the management server 1700 in the case of expanding with respect to the means for a remote access to the system will be described.

In the above embodiments, as means for the remote access to the access destination resource in the system from the user terminal, the means using a display screen transfer protocol as represented by RDP (Remote Desktop Protocol) has been shown as an example. However, when considering such a spirit of the invention that the information disclosure range is dynamically controlled according to the situation upon accessing, the remote access means is not necessarily limited to the means using the display screen transfer in particular. For example, the user can adopt a using method whereby a file of a shared folder in the access destination resource is directly accessed from the user terminal at the destination and the contents of this file on the user terminal at the destination are developed or a using method whereby he directly connects from the user terminal at the destination to a certain server of the access destination resource by a protocol such as TELNET (communication protocol with a remote terminal in a standard IP network defined by RFC854) or the like.

In the case of adopting such a using method as mentioned above, the management server 1700 needs to expand the function with respect to the following two points.

First, the management server 1700 provides a column which defines a type of remote access service, a protocol name, or the like (hereinbelow, such a column is called a filtering target service column) in the filtering policy 1703 as a table which is managed by the management server itself.

Second, the filtering control module 5003 for reading the filtering policy 1703 and requesting the switch 1500 to make the access control by using such information reads the information defined by the filtering target service column and forms such an ACL as to make a port opening/closure definition to the protocol name (type) of the filtering target service column by using such information.

When adopting such a using method as mentioned above, it is sufficient that the administrator or the user merely changes the protocol serving as an access control target for the filtering target service column, for example, from the RDP protocol for realizing the display screen transfer to the TELNET protocol. It is unnecessary to make the system expansion other than the foregoing function expansion upon realization of the present function. The functions introduced in the first embodiment can be diverted as they are.

### Embodiment 14

Subsequently, an expansion of the situation information will be described as a fourteenth embodiment. Unlike the meta situation information as mentioned in the ninth embodiment, in the embodiment, an expansion is made with respect to the situation information regarding the user access which is directly established right now.

In the above embodiments, as situation information of the connecting source, in brief, information regarding “who” and “from where” the access has been made can be obtained in a real-time manner. If the meta situation information such as schedule information and the like is added, information regarding “from when”, “until when”, “for what purpose”, and the like is decorated to it. On the other hand, it is an object of the embodiment to further enhance the security by raising precision of the situation information itself. With respect to the situation information which can be obtained as mentioned above, such situation information that the access is made “by using which machine” and “to which access destination resource” is expanded.

If the user or the administrator has obviously and previously known the range of the access destination resource of the user, on the basis of information of the access range which could be explicitly known by either a method whereby which resource it is necessary to access can be known by a notification from the user side or a method whereby it can be known by the setting from the administrator when the administrator restricts the access range according to an object such as security, maintenance, or the like, the information existing in the access range which has previously been permitted, that is, the whole information is not opened but the disclosure range is limited to the necessary least disclosure range regarding the connection, and the information within such a limited range is disclosed. Thus, such a resource that although there is an access permission, it is opened in spite of the fact that it is not accessed right now does not occur, and the user can also work at a destination without any worries.

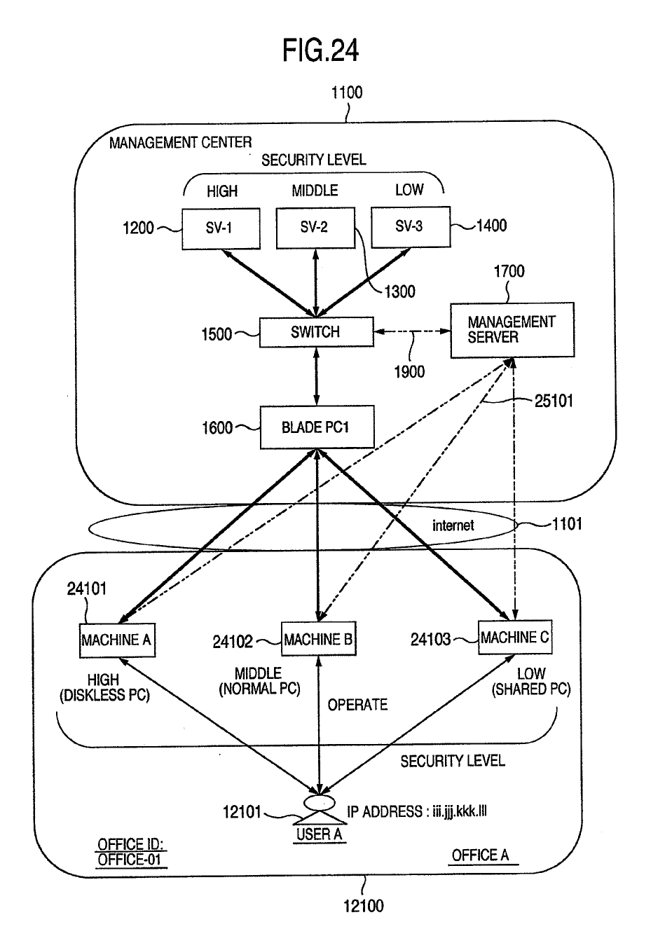

FIG. 24 shows a fundamental system construction of the embodiment.

A plurality of servers such as server SV-1 (1200), server SV-2 (1300), and server SV-3 (1400) of different security levels are provided in the management center 1100. Those security levels are assumed to be high, middle, and low. A correspondence relation between the security levels and the access destination resources can be managed as a part of the information of the filtering policy 1703 which is managed by the management server 1700 or may exist as another setting file in the management server 1700. The security level is designated in the setting file by one of the following two systems. The first is a method whereby the servers serving as access destination resources are designated one by one by the individual IP address. The second is a method whereby a plurality of servers are collectively designated by designating a range of the IP address. The security level may be a security level which is allocated to the server itself or a security level which is allocated to the data that can be accessed by the user. It is also assumed that the user-A (12101) exists in the office-A (12100) serving as an accessing source and the access to the access destination resource is tried while selectively using a plurality of machines such as machine-A (24101), machine-B (24102), and machine-C (24103) according to an object. At this time, various variations are presumed as a machine serving as a working terminal. The machine-A (24101) is a machine having the high security level of such a type that a hard disk apparatus is not built in the main body, and by connecting the machine to the hard disk apparatus provided in a remote site and using it, application data, a log file, and the like serving as a work history are not left in the terminal at hand. The machine-B (24102) is a PC of such a normal type that it is distributed to each user and the hard disk apparatus has been built in the main body and is also a machine having a normal security level. The machine-C (24103) is a machine which is used in common in a destination office and is handled as a machine having a low security level in the embodiment in such a sense that a plurality of unspecified users use it.

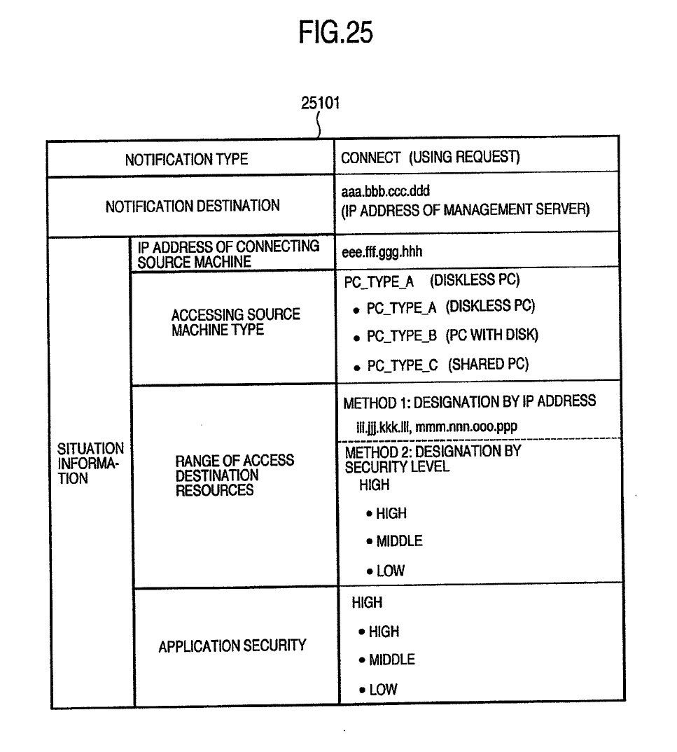

The user-A (12101) tries to connect by a sequence similar to that in the first embodiment when connecting to the system. The using request notification 1902 in the first embodiment has such a data structure having the notification type, the notification destination, and only one situation information as shown in FIG. 3A. However, in the embodiment, it is expanded to a using request notification 25101 as shown in FIG. 25, that is, to a data structure having a notification type, a notification destination, and a plurality of situation information. Specifically speaking, the plurality of situation information is constructed by columns of an IP address of the connecting source machine, a machine type of an accessing source, a range of the access destination resources, and an application security. It is sufficient that there is at least one of those columns and it is not always necessary that all of the columns are provided. The administrator can increase or decrease the necessary columns according to an operation scene and set them.

Each column will be described hereinbelow. In a manner similar to the first embodiment, with respect to only any one of the machines of the machine-A (24101), machine-B (24102), and machine-C (24103), a value of the IP address of the machine which is being used at present is inserted in the IP address column of the connecting source machine. In the case of the machine-A (24101), an identifier “PC_TYPE_A” indicative of the diskless PC is inserted in the accessing source machine type column and, in the case of the machine-B (24102), an identifier “PC_TYPE_B” indicative of the PC with the disk is inserted there, and in the case of the machine-C (24103), an identifier “PC_TYPE_C” indicative of the shared PC is inserted there. In the column of the access destination resource range, the range of the resources which the user wants to access at present is designated by one of the following systems. As a first system, there is a method whereby by designating a plurality of IP addresses, the disclosure is obtained with respect to a plurality of limited resources in a manner similar to the designation of the connecting source machine. As a second system, there is a method whereby by designating the security level, the disclosure is obtained in a lump with respect to a plurality of resources limited to the resource corresponding to the security level. A result leveled by integratedly discriminating the executing situation of a security countermeasure at the application level such as introducing situation of security software, virus check result, installing situation of illegal software, and the like is inserted in the application security column. Such a discrimination can be made by a mechanism in which the machine has such a software agent as to discriminate the executing situation of the security countermeasure with respect to each of the machines such as machine-A (24101), machine-B (24102), and machine-C (24103) on the user side which are used by the user-A (12101) and notify the management server 1700 of the executing situation and the management server passively receives it or by a mechanism in which the software agent is not built in the machine on the user side but, in place of it, the timing when the using request notification 25101 has been received is used as a trigger and the inspection of the security level is actively made from the management server 1700 at a remote place to the machine on the user side. The foregoing software agent may have a reference of the inspection of each security level as a setting file or the management server 1700 may have such a reference as a part of the filtering policy 1703.

It is assumed that when the disclosure of the access destination resources is finally performed with respect to each of the security levels of the accessing source machine type, the range of the access destination resources, and the application security, the lowest security level among them is used as a reference and the information is disclosed. For example, in the case where the accessing source machine type is “PC_TYPE_A”, it has been set so that “PC_TYPE_A” has the highest security level, and although the range of the access destination resources is “HIGH”, the application security is “LOW”, although the disclosure request and the machine which is used has the highest security level, it is determined that the countermeasure against the application security is insufficient, and the information which is actually disclosed is limited up to the information of the low “LOW” security level.

It is assumed that the notification which needs the expansion in the embodiment is only the foregoing using request notification 25101 and the same data structure as that in the first embodiment is used with respect to the preparation result notification 1904, end request notification 1903, and end result notification 1905.

In the embodiment, it is assumed that when connecting from the office-A (12100), the user-A (12101) accesses always by using an IP address: iii.jjj.kkk.lll even if any machine is used. It is also assumed that an initial setting of such a filtering policy 1703 that all of the servers SV-1 (1200), SV-2 (1300), and SV-3 (1300) existing in the management server 1700 are disclosed in response to the access from the IP address: iii.jjj.kkk.lll has been made in the filtering policy 1703 by the administrator or the user.

As an example of an action in the case where only the security level of the connecting source machine has been designated, such a setting of a filtering policy 1703 that only the resources below the designated security level can be accessed is considered. In the embodiment, it is assumed that the machine of the high security level can access all of the servers of the high, middle, and low security levels, the machine of the middle security level can access only the two servers of the middle and low security levels, and the machine of the low security level can access only the server of the low security level.

At this time, a case where the user-A (12101) wants to connect to the server SV-3 (1400) as a server of the lowest security level by using the machine-A (24101) as a machine of the highest security level is presumed.

A fundamental processing sequence will be described hereinbelow.

From the machine-A (24101), the user-A (12101) transmits the using request notification 25101 in which the IP address of the machine-A (24101) has been set as an IP address of the accessing source machine, “PC_TYPE_A” has been set as an accessing source machine type, “LOW” has been set as an access destination resource range, and “HIGH” has been set as an application security. At a point of time when the preparation result notification 1904 responsive to the using request notification 25101 has been received, the user-A (12101) can access only the server SV-3 (1400) of the lowest security level which was notified from the machine-A (24101) that it is used at present in spite of the fact that the setting in which all of the servers can be accessed has been made in the filtering policy 1703.

Subsequently, from the machine-B (24102), the user-A (12101) transmits the using request notification 25101 in which the IP address of the machine-B (24102) has been set as an IP address of the accessing source machine, “PC_TYPE_B” has been set as an accessing source machine type, the IP address of the server SV-2 (1300) has been set as an access destination resource range, and “MIDDLE” has been set as an application security. At a point of time when the preparation result notification 1904 responsive to the using request notification 25101 has been received, the user-A (12101) can access only the server SV-2 (1300) which was notified that it is used at present between the servers SV-2 (1300) and SV-3 (1400) as a resource disclosure range according to the security level of the machine-B (24102) without requesting the administrator to change the filtering policy, or the like.

Subsequently, from the machine-C (24103), the user-A (12101) transmits the using request notification 25101 in which the IP address of the machine-C (24103) has been set as an IP address of the accessing source machine, “PC_TYPE_C” has been set as an accessing source machine type, “MIDDLE” has been set as an access destination resource range, and “MIDDLE” has been set as an application security. At a point of time when the preparation result notification 1904 responsive to the using request notification 25101 has been received, the user-A (12101) can access only the server SV-3 between the servers SV-2 (1300) and SV-3 (1400) as a disclosure range of the resources requested from the machine-C (24103) without changing the filtering policy. By explicitly notifying of the access range from the user, the information can be disclosed while narrowing to the necessary least range. However, when the notification of the user is wrong, there is a risk that the information of an amount larger than it is needed is disclosed. Therefore, even if the notification of the user is wrong, by integratedly discriminating the items of a plurality of security levels as shown in this example, the information in the proper disclosure range is disclosed.

Although several patterns of the combination of the accessing source and the access destination have been described as mentioned above, the embodiment intends to realize the disclosure in the necessary least range by discriminating the situation information from many sides in consideration of the combination of the access authority and the using methods with respect to the network, the physical (operation policy of the security on a server unit basis)/logical (security property of the data itself) of the access destination machine, physical (machine type)/logical (application) of the accessing source machine, and the like. Such a construction is a function that is effective as a countermeasure against an information leakage in the case where a demonstration, creation of references, or the like is being executed at a destination while surrounding a display screen of the same terminal together with the customers, or the like.

### Embodiment 15

Subsequently, a construction which copes with the multi-users will be described as a fifteenth embodiment. In the above embodiments, the explanation has been made on the assumption that one user occupies one blade PC serving as a relay apparatus. However, a using method of sharing the blade PC by a plurality of users is also presumed as one operation forms for the purpose of reducing an investment in plant and equipment or the like. A mechanism which can perform the optimum information disclosure that is independent every user even in such a case will be described hereinbelow.

The following two patterns are mainly considered as a using method of sharing the blade PC by a plurality of users. As a first pattern, a using method whereby although a plurality of users do not simultaneously access, the connections from the different users are accepted one after another (hereinbelow, such a method is called a time-division access) is considered. As a second pattern, a using method whereby the accesses from a plurality of users are always accepted (hereinbelow, such a method is called a multistage access) is considered. The expanding function necessary for the invention will be described hereinbelow with respect to each of those patterns.

In the time-division access, since the number of users who access the blade PC in a lump is equal to only one, in order to identify the path of the user access, if only the correspondence relation between the blade PC which is being accessed and the access destination resource is grasped, the path can be identified. Therefore, the expanding function is unnecessary.

In the multistage access, since the number of users who access the blade PC in a lump is equal to a plural number, even if the correspondence relation between the blade PC which is being accessed and the access destination resource is merely grasped, the path of the user access cannot be identified. In such a case, it is necessary to identify the path on a session unit basis instead of the machine unit basis. In the present case, control is made by using the resource disclosure range control agent 8200 without using the management server 1700. The filtering module 10306 held by the resource disclosure range control agent 8200 grasps the correspondence relations among the user, the user session, the machine, and the port. Specifically speaking, session information of the user access of the user which accessed each blade is detected and each session grasps that the communication with the access destination resource is made by using which logical port or physical port. Thus, in the case where the using request notifications have been transmitted to the same blade PC from a plurality of users, the filtering module 10306 makes the access control to each user on a port unit basis for the firewall 8300, so that it is possible to realize such a construction that even if the same blade PC is accessed, although only the server SV-1 (1200) is disclosed for the session of access by a certain user, the server SV-1 (1200), server SV-2 (1300), and server SV-3 (1400) are disclosed for the session of access by another user.

### Embodiment 16

Subsequently, an example of further expanding the using method shown in the sixth embodiment will be shown as a sixteenth embodiment. In the sixth embodiment, as an expansion of the position discriminating method, the function of controlling the information disclosure range on the basis of the information showing from which base point the user has connected by the office IDs which are managed by the entering/leaving room management server 12107, 12205, or the like at each base point has been shown as an example. In the embodiment, a countermeasure in the case where the connection from the same user has been tried from different offices by presuming the system in which the management of the office IDs is made by the sixth embodiment will be described.

Inherently, the user identifier is an identifier for uniquely identifying the user and should be the information in which a plurality of information have not to exist. However, in the case where the user identifier is duplicated by an attacker due to some causes and a situation where a plurality of user identifiers exist occurs, there is a possibility of occurrence of an illegal access. Specifically speaking, it is considered that a possibility that the user identifier is superimposed into data such as an electronic certificate is high. Therefore, a possibility that the electronic certificate of the regular user leaks as a file by some causes is considered. In such a case, such a situation that the attacker possesses a duplicate of the certificate can be presumed. In this case, since the regular user and the attacker transmit the using request notification 1702 by using the same certificate (same user identifier), the administrator cannot distinguish the regular user from the attacker in this state. For such a doubtful situation where a plurality of terminals are simultaneously connected by the user identifier in which only one user identifier exists inherently as mentioned above, any one of the following two countermeasures may be taken by the filtering control module 5003.

First, both of the doubtful connections are disconnected and a notification showing that there is an illegal access is transmitted to the administrator.

The second is a mechanism in which by collating both of the apparently doubtful connections with the meta situation information, the regular user and the attacker are identified, both of the connections are not abolished but only the connection of the regular user is left, and only the connection of the attacker is abolished. Specifically speaking, it is a method whereby by confirming the coincidence by collating with the application of a business trip and the schedule information, even in the same user identifier, in which using request notification 1702 the correct office ID is included as an inherent connecting source is discriminated, and only the connection of the regular user in which the correct office ID is included is left.

While the present invention has been described with reference to the particular illustrative embodiments, it is not to be restricted by those embodiments but only by the appended claims. It is to be appreciated that those skilled in the art can change or modify the embodiments without departing from the scope and spirit of the present invention.

1. An access control system having a user terminal, a relay apparatus, and a management server which are connected through a network,
said management server comprises:
a storing apparatus having position information regarding a position of said user terminal, user information regarding a user of said user terminal, and in the case where said relay apparatus accesses said user terminal, a filtering policy as information with which a range of a storing device held in said relay apparatus whose access is permitted from said user terminal has been associated; and
an access control unit having a notifying processing unit which receives an access request from said user terminal to said relay apparatus, a situation information collecting unit which obtains an identifier of said user terminal and said position information from said access request and obtains said user information from the relay apparatus as a target of said access request after said access request was received, a policy collating unit which collates said identifier of said user terminal, said position information, and said user information which were obtained with said filtering policy, and a filtering control unit which controls a firewall held in said relay apparatus so that said user terminal can access said relay apparatus only for the range determined as a result of said collation.

2. The access control system according to claim 1, wherein:
said management server further has:
a resource managing unit which monitors a state of the storing device of said relay apparatus; and
a maintenance unit which receives a notification that is made in the case where the storing device of said relay apparatus has been added, changed, or deleted from said resource managing unit and updates said filtering policy in accordance with said addition, change, or deletion.

3. The access control system according to claim 2, wherein:
said position information includes presence information of said user, and
said user information includes schedule information, an object of a business trip, a destination of the business trip, and an access object regarding the user of said user terminal.

4. The access control system according to claim 3, wherein:
said presence information further includes information regarding a base point where said user uses the user terminal, and
when said user uses the user terminal, said user terminal obtains the information regarding the base point from an entering/leaving room management server which makes an entering/leaving room management of said base point that is used.

5. The access control system according to claim 3, wherein:
said presence information further includes information regarding a base point where said user uses the user terminal, and
said user terminal obtains the information regarding the base point where said user terminal is used from a GPS held in its own terminal.

6. The access control system according to claim 4, wherein:
said user information further includes information regarding an office organization and a business in the user of said user terminal.

7. The access control system according to claim 6, wherein:
when said notifying processing unit receives a plurality of access requests from said user terminals to said relay apparatus, if identifiers of the user terminals of transmitting sources of said access request are identical and the information regarding said base point obtained from the user terminals is different,
said filtering control unit inhibits the accesses to said relay apparatus from said user terminals as said transmitting sources of said received plurality of access requests.

8. The access control system according to claim 7, wherein:
there are a plurality of said relay apparatuses,
said management server further
has a multi-access management file showing permission/inhibition of the access from the relay apparatus to another relay apparatus in the storing apparatus, and
when said user terminal accesses said another relay apparatus through the relay apparatus which is accessed by said user terminal, said user terminal transmits an access request to said another relay apparatus to said management server, and in the case where said management server permits the access with reference to said multi-access management file, said user terminal can access said another relay apparatus.

9. The access control system according to claim 8, wherein:
said system further comprises a switch, and
said filtering control unit controls said switch in place of the firewall of said relay apparatus in such a manner that said user terminal can access said relay apparatus only for the range determined as a result of said collation.

10. The access control system according to claim 9, wherein:
said relay apparatus is a blade PC.

11. An access control system having a user terminal, a management server, a relay apparatus which is accessed by said user terminal, a processing server which is accessed by said user terminal through said relay apparatus, and a switch which controls said user terminal by connecting through a network,
said management server comprises:
a storing apparatus having position information regarding a position of said user terminal, user information regarding a user of said user terminal, and in the case where said user terminal accesses said relay apparatus, a filtering policy as information with which said processing server which can be accessed by said user terminal through said relay apparatus has been associated; and
an access control unit having a notifying processing unit which receives an access request from said user terminal to said relay apparatus, a situation information collecting unit which obtains an identifier of said user terminal and said position information from said access request and obtains said user information from the relay apparatus as a target of said access request after said access request was received, a policy collating unit which collates said identifier of said user terminal, said position information, and said user information which were obtained with said filtering policy, and a filtering control unit which controls said switch so that said user terminal can access only said processing server determined as a result of said collation through said relay apparatus.

12. The access control system according to claim 11, wherein:
said management server further has:
a resource managing unit which monitors a state of a storing device of said relay apparatus; and
a maintenance unit which receives from said resource managing unit a notification that is made in the case where a storing device of said relay apparatus has been added, changed, or deleted, and updates from said resource managing unit and updates said filtering policy in accordance with said addition, change, or deletion.

13. The access control system according to claim 12, wherein:
said position information includes presence information of said user, and
said user information includes schedule information, an object of a business trip, a destination of the business trip, and an access object regarding the user of said user terminal.

14. The access control system according to claim 13, wherein:
said presence information further includes information regarding a base point where said user uses the user terminal, and
when said user uses the user terminal, said user terminal obtains the information regarding the base point from an entering/leaving room management server which makes an entering/leaving room management of said base point that is used.

15. The access control system according to claim 13, wherein:
said presence information further includes information regarding a base point where said user uses the user terminal, and
said user terminal obtains the information regarding the base point where said user terminal is used from a GPS held in its own terminal.

16. The access control system according to claim 14, wherein:
said user information further includes information regarding an office organization and a business in the user of said user terminal.

17. The access control system according to claim 16, wherein:
when said notifying processing unit receives a plurality of access requests from said user terminals to said relay apparatus, if identifiers of the user terminals of transmitting sources of said access requests are identical and the information regarding said base point obtained from the user terminals is different,
said filtering control unit inhibits the accesses to said relay apparatus from said user terminals as said transmitting sources of said received plurality of access requests.

18. The access control system according to claim 17, wherein:
there are a plurality of said relay apparatuses,
said management server further
has a multi-access management file showing permission/inhibition of the access from the relay apparatus to another relay apparatus in the storing apparatus, and
when said user terminal accesses said another relay apparatus through the relay apparatus which is accessed by said user terminal, said user terminal transmits an access request to said another relay apparatus to said management server, and in the case where said management server permits the access with reference to said multi-access management file, said user terminal can access said another relay apparatus.

19. The access control system according to claim 18, wherein:
said system further comprises a switch, and said filtering control unit controls said switch in place of a firewall of said relay apparatus in such a manner that said user terminal can access said relay apparatus only for a range determined as a result of said collation.

20. The access control system according to claim 19, wherein:
said relay apparatus is a blade PC.
